(19) United States
(12) Patent Application Publication
(10) Pub. No.: US 2017/0154353 A1
(43) Pub. Date: Jun. 1, 2017

(54) SYSTEMS AND METHODS FOR GENERATING A TRIPSCORE

(71) Applicant: TripStreak Holdings, LLC, Atlanta, GA (US)

(72) Inventor: Charles Ralston, Manhattan Beach, CA (US)

(21) Appl. No.: 15/295,454

(22) Filed: Oct. 17, 2016

Related U.S. Application Data
(60) Provisional application No. 62/245,097, filed on Oct. 22, 2015.

(51) Int. Cl. G06Q 30/02; G06Q 30/06; G06F 17/30

(52) U.S. Cl. CPC G06Q 30/0226; G06F 17/30867; G06F 17/3053; G06Q 30/0625

(57) ABSTRACT

A method of generating a TRIPSCORE receiving, by one or more servers from a client device, a search request comprising trip information and identifying a plurality of itineraries based on the trip information. The method further includes retrieving, by the one or more servers from a data store, preference information including a plurality of preferences and a ranking of a ranked subset of the plurality of preferences, determining, by the one or more servers for each itinerary, a correspondence between the respective itinerary and each respective preference of the plurality of preferences, calculating, by the one or more servers for each itinerary, a TRIPSCORE for each itinerary based on the correspondences, wherein each correspondence between the itinerary and a preference of the ranked subset of preferences is weighted based on the ranking of preferences, and displaying, by the one or more servers, a number of itineraries having a highest TRIPSCORE.

### CROSS-REFERENCE TO RELATED PATENT APPLICATIONS

This application claims priority to U.S. Provisional Application 62/245,097, filed Oct. 22, 2015, entitled “SYSTEMS AND METHODS FOR PROVIDING TRAVEL BOOKING SERVICES,” the entirety of which is incorporated herein by reference.

### BACKGROUND

Online travel agencies typically allow a travel inquirer to search a vast array of travel options, including flights, hotels, rental cars, cruises, etc. Each of these then require the travel inquirer to sort through hundreds or thousands of options before they finally make a purchase. These websites operate on generally the same principles. Although each offers a different format, the result is essentially the same: the travel inquirer can manually find results based on their individual preferences, which can be a slow process. The majority of travel inquirers spend at least one hour planning and booking a trip. The systems and methods described herein leverage technology to make this process more efficient for the travel inquirer.

### SUMMARY

At least one implementation is directed to a method of generating a TRIPSCORE. The method includes receiving, by one or more servers from a client device, a search request, the search request comprising trip information, and identifying, by the one or more servers, a plurality of itineraries based on the trip information. The method further includes retrieving, by the one or more servers from a data store, preference information including a plurality of preferences and a ranking of a ranked subset of the plurality of preferences, determining, by the one or more servers for each itinerary, a correspondence between the respective itinerary and each respective preference of the plurality of preferences, calculating, by the one or more servers for each itinerary, a TRIPSCORE for each itinerary based on the correspondences, wherein each correspondence between the itinerary and a preference of the ranked subset of preferences is weighted based on the ranking of preferences, and displaying, by the one or more servers, a predetermined number of itineraries having a highest TRIPSCORE.

Another implementation is directed to a method for configuring a travel account. The method includes receiving, by one or more servers from a client device, a search request comprising trip information, and transmitting, by the one or more servers to the client device, graphical user interface information that, when executed, causes to be displayed a graphical user interface, wherein the graphical user interface displays an interactive object comprising a predetermined number of preferences in a predetermined ranked order, allows the preferences to be reordered via interaction with the interactive object, and provides an option to save the order of the preferences. The method further includes identifying, by the one or more servers, a plurality of itineraries based on the trip information, retrieving, by the one or more servers from a data store, preference information including a plurality of preferences and a ranking of a ranked subset of the plurality of preferences, determine, by the one or more servers for each itinerary, a correspondence between the respective itinerary and each respective preference of the plurality of preferences, calculating, by the one or more servers for each itinerary, a TRIPSCORE for each itinerary based on the correspondences, wherein each correspondence between the itinerary and a preference of the ranked subset of preferences is weighted based on the ranking of preferences, and displaying, by the one or more servers, a predetermined number of itineraries having a highest TRIPSCORE.

Yet another implementation is direct to a system for generating a TRIPSCORE. The system includes a processor and a memory coupled to the processor, the memory storing computer-executable instructions, which when executed by the processor, cause the processor to receive, by one or more servers from a client device, a search request, the search request comprising trip information, identify, by the one or more servers, a plurality of itineraries based on the trip information, and retrieve, by the one or more servers from a data store, preference information including a plurality of preferences and a ranking of a ranked subset of the plurality of preferences. The computer-executable instructions, when executed by the processor, further cause the processor to determine, by the one or more servers for each itinerary, a correspondence between the respective itinerary and each respective preference of the plurality of preferences, calculate, by the one or more servers for each itinerary, a TRIPSCORE for each itinerary based on the correspondences, wherein each correspondence between the itinerary and a preference of the ranked subset of preferences is weighted based on the ranking of preferences, and display, by the one or more servers, a predetermined number of itineraries having a highest TRIPSCORE.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1A depicts an example implementation of a graphical user interface for selecting a travel itinerary.

FIG. 1B depicts an example implementation of a graphical user interface for ranking preferences and for selecting preference options.

FIG. 2 depicts an example implementation of a TRIPSCORE server 200 for generating a TRIPSCORE.

FIG. 3 depicts an example implementation of a method 330 for assigning weight points to a predetermined list of preferences.

FIG. 4A depicts an overview of a portion of an example implementation of a method 400 for generating a TRIPSCORE for an itinerary.

FIG. 4B depicts an overview of another portion of the example implementation of a method 400 for generating a TRIPSCORE for an itinerary.

FIG. 5 depicts an example implementation of a method for generating a TRIPSCORE via processes executed in parallel.

FIG. 6 depicts an example implementation of a method for retrieving preferences.

FIG. 7 depicts a screenshots of an example implementations of a graphical user interface for submitting a search request.

FIG. 8 depicts a screenshots of an example implementations of a graphical user interface for ranking preferences and for selecting preference options related to flights.

FIG. 9 depicts an example implementation a graphical user interface for ranking preferences and for selecting preference options related to hotels.

FIG. 10 depicts an example implementation a graphical user interface for ranking preferences and for selecting preference options related to cars.

FIG. 11 depicts an example implementation a graphical user interface for displaying flight itineraries ranked by TRIPSCORE.

FIG. 12 depicts an example implementation a graphical user interface for displaying hotel itineraries ranked by TRIPSCORE.

FIG. 13 depicts an example implementation a graphical user interface for displaying car itineraries ranked by TRIPSCORE.

FIG. 14 depicts an example implementation a graphical user interface for displaying a shopping cart that includes a hotel itinerary, a flight itinerary, and a car itinerary.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Present embodiments of the TRIPSCORE algorithm include, but are not limited to, providing a numerical value that indicates to the travel inquirer travel itineraries that best fit their needs. This can be done as a weighted average that measures a travel inquirer's preferences against available air, hotel, or ground transportation inventory, and it can depend on either predetermined weights for those preferences or on the travel inquirer defining weights for those preferences. This can be useful for a number of reasons, including time saved for the travel inquirer and providing the travel inquirer with information and/or booking opportunities most relevant to their desires.

The TRIPSCORE empowers travel inquirers to efficiently produce the itinerary they want, based on specific aspects of travel that they like as compared to those that they don't like. This can be accomplished in a number of ways, including by creating a user profile with relevant information stored in a data store, such as a secure cloud-based storage system. Travel inquirers can save preferences in their profile or user account during a first use or during a subsequent use of a TRIPSCORE system, method or portal, and can edit those preferences at a later date. As used herein, the term “preferences” can refer to preferences, to options related to a preference, to sub-preferences, or to rankings of preferences. The preferences or preference parameters can include, and are not limited to, any of: airline preference, loyalty programs, cost tolerance, connections and layover duration, redeyes, aircraft type, frequent flyer mile earning priorities, flexibility (refundable, applicable change fees, cancellation policies), lodging room or bed preferences, rental car preferences, preferred hotel programs, hotel star rating preferences, hotel user rating preferences, hotel cost preferences, hotel special rate preferences, hotel flexible rate preferences, hotel preferred amenities preferences, hotel proximity or closeness to destination preferences, preferred vehicle class, lowest vehicle cost preferences, rental car pickup/drop-off proximity to airport preferences, preferred car programs, and preferred amenities.

Airline preferences can include, for example, one or more preferred airlines, or one or more disliked airlines, or can include a ranking of airlines, or can include relative airline preferences between airlines. Airline preferences can include general categories of preferences related to airlines, rather than preferences related to specific airlines (e.g. a preference for American-owned airlines, or a preference for Airlines that are environmentally friendly).

Loyalty program preferences can include, for example, a favorite loyalty program, or a ranking of loyalty programs, such as a favorite hotel loyalty program, a favorite car rental loyalty program, or a favorite airline loyalty program. Loyalty program preferences can include information related to loyalty programs in which the travel inquirer is enrolled or in which the travel inquirer is able to enroll. This information can include current loyalty point totals, goods or services available for purchase with a number loyalty points available in a loyalty points account or goods or services that will be available for purchase after a potential travel itinerary is completed or booked, the goods or services purchased either solely with loyalty points or in combination with negotiable funds. The goods or services can include, for example, travel goods or services (e.g. flights, hotels, cars, or upgrades related to flights, hotels, cars), or non-travel related goods or services.

Cost tolerance preferences can include, for example, a range of acceptable costs for a travel itinerary or for portions of a travel itinerary, such as a flight, lodging, or ground transportation portion. Cost tolerances can include multiple ranges of costs in a preferred ranked order, such as a most preferred price range, a less preferred price range, and an unacceptable price range. A lowest cost preference can also be a preference for a lowest cost option of a variety of options.

Connections and layover duration preferences can include, for example, any preference related to a number of connections required to complete a trip, such as airplane connections or ground transport connections (e.g. using a shuttle to connect two flight portions of a trip). Connections and layover duration preferences can also include layover or wait time preferences, such as preferences related to a time required to wait between portions of a trips (such as, for example, time between two flights at a same airport or at different airports, or time required to wait for a bus or shuttle to arrive at a bus or shuttle stop). Layover or wait time preferences can include a range of total acceptable wait times or a maximum total acceptable wait time (which can comprise a plurality of individual wait times respectively corresponding to a plurality connections between portions of a trip), or can include a range of individual acceptable wait times or a maximum individual acceptable wait time (which can be single wait time corresponding to a single connection between portions of a trip). Connections and layover duration preferences can include a preference for the shortest allowable or shortest possible layover.

Redeye preferences can include, for example, any preference related to redeye travel, which can be travel that correspond to a predetermined or to a user defined time frame. For example, a flight can be considered a redeye flight if it departs or arrives between 1 AM (e.g. as calculated from a departure point time zone or from an arrival point time zone, respectively) and 5 AM. Redeye time frames can be defined as window of time. Redeye preferences can relate to any of defining a time frame for redeye travel, a preference for redeye travel or a preference for non-redeye travel (i.e. a preference option), or any other appropriate preference.

Aircraft type preferences can include, for example, a preference for widebody, narrowbody, regional jet, or turboprop aircraft. A travel inquirer can indicate a preference for an aircraft type, or can indicate that any number of particular aircraft types are to be avoided.

Frequent flyer mile earning priorities preferences can include, for example, a frequent flyer program in which a travel booker is enrolled. Multiple programs can be indicated by the frequent flyer mile preferences. In such cases, the programs can be ranked relative to each other in terms of preference. For example, a travel inquirer can rank the programs in descending order or give any or all of them equal weighting. Frequent flyer mile priorities can include a preference for redeemable miles or status miles.

Flexibility preferences can include, for example, a preference for travel arrangements that comply with particular refund policies or preferences (e.g. provide cancellation refunds within 24 hours of an itinerary start time, or within 48 hours of an itinerary start time, or within a predetermined or a user-specified number of hours of an itinerary start time). Flexibility preferences can include preferences related to fees charged for changes to an itinerary or to cancellations.

Lodging preferences can include, for example, preferred hotel or lodging programs, lodging star rating preferences, lodging user rating preferences, lodging cost preferences, lodging special rate preferences, lodging flexible rate preferences, lodging preferred amenities preferences, lodging proximity or closeness to destination preferences, or lodging room or bed preferences related to a number of rooms in a lodging (e.g. a predetermined or user-determined number of bedrooms or bathrooms, a preference for a kitchen unit, or a preference for a balcony) or a number or type of bed available in a lodging. Lodging room or bed preferences can also include a preference for bed types, e.g. a single bed, a queen sized bed, a king sized bed, or any combination of particularly-sized beds. Lodging can include any type of lodging, including, for example, hotels, bed and breakfasts, homes, apartments, or rooms for rent.

Lodging or hotel ratings preferences can include preferences related to lodging star ratings, lodging ratings from rating agencies that rate lodgings, or user ratings for lodgings. For example, a preference may be for a lodging that is rated a minimum number of stars by a predetermined or user-specified rating agency, or by a user-rating agency, website, or other publication. A preference may be for a top voted lodging any of the above-described rating parties, or for a lodging within a top voted number of lodging (e.g. with the top-ten voted lodging).

Rental car preferences can include, for example, preferred vehicle class, lowest vehicle cost preferences, rental car pickup/drop-off proximity to airport preferences, preferred car programs, or preferred amenities preferences. Preferred vehicle class preferences can be a preference for a preferred rental car class, make, or model. Rental car preferences can also include preferred price range for rental cars. The preferences can include a top preference or can include a preference ranking. Rental car preferences can include other preferences, including preferences for environmentally friendly cars, for cars meeting gas efficiency preferences, for cars equipped with entertainment systems (e.g. an internet radio or other radio system), for cars having air conditioning systems, for cars having four wheel drive, for cars that include an option of insurance or that come with insurance, or for a car type, such as truck, sports utility vehicle, sedan, motorcycle, van, pickup truck, or other type of car.

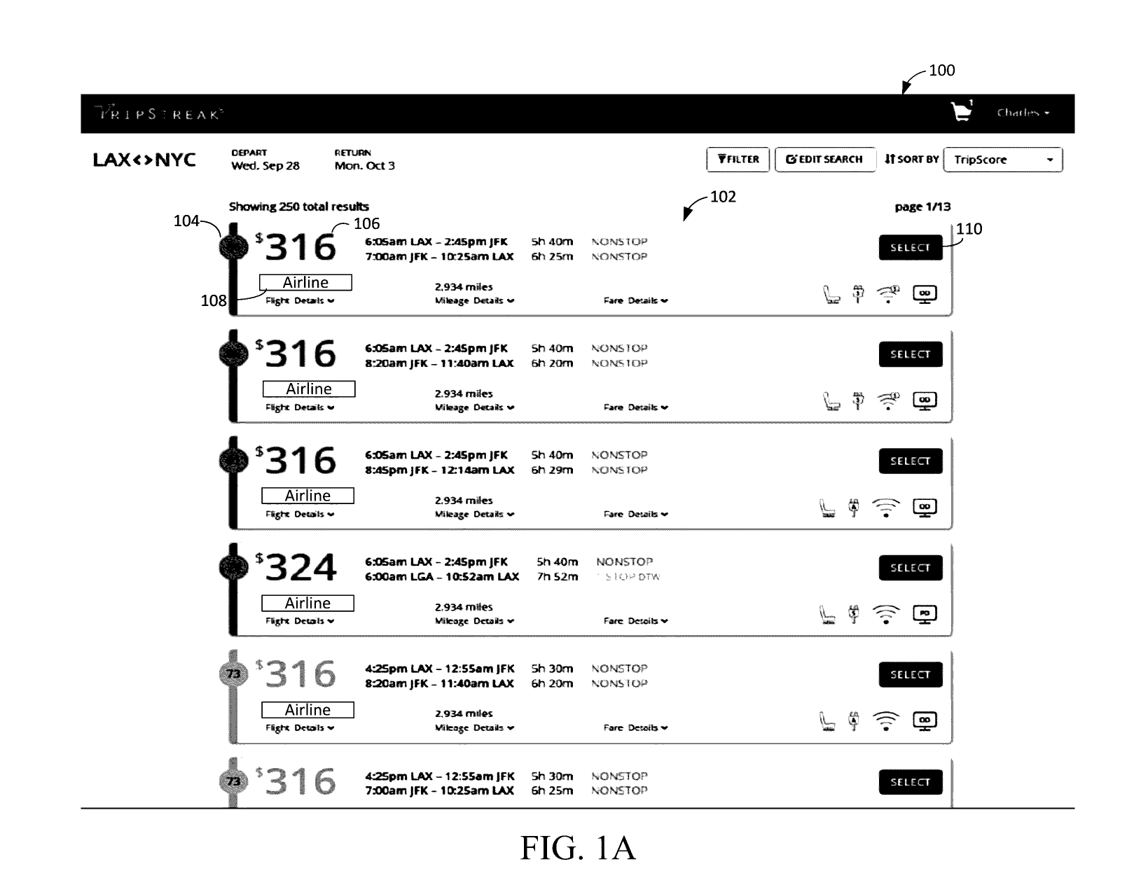

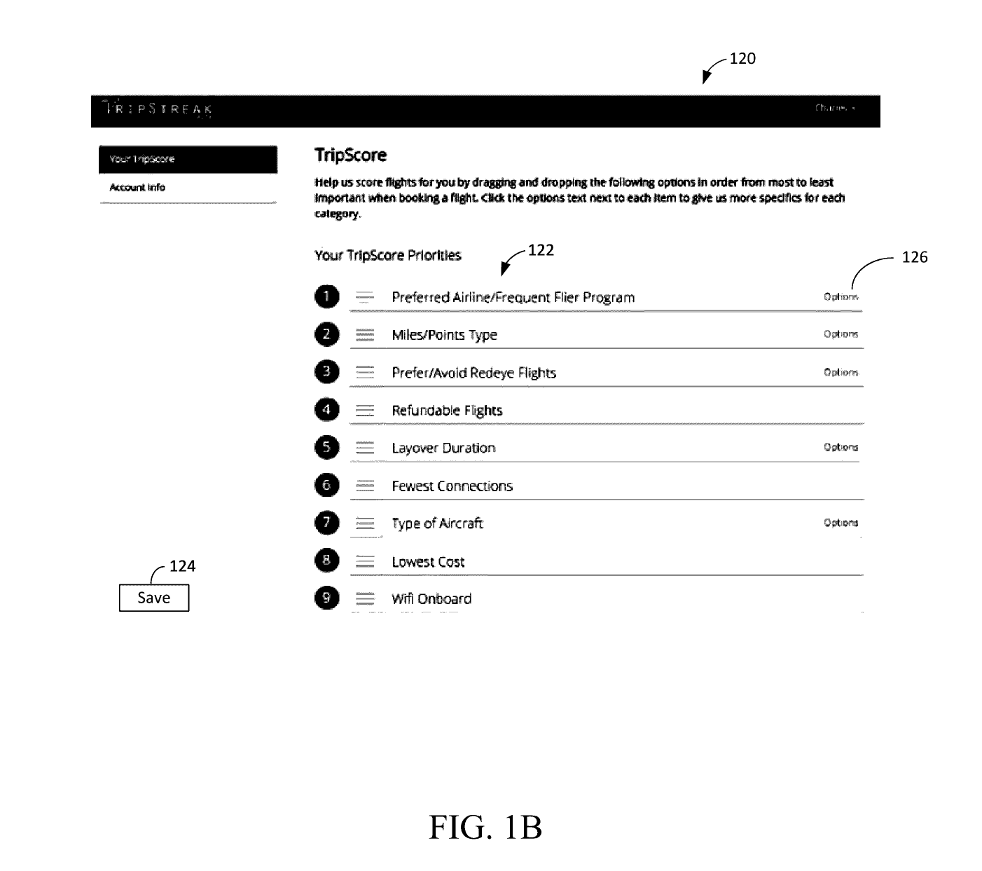

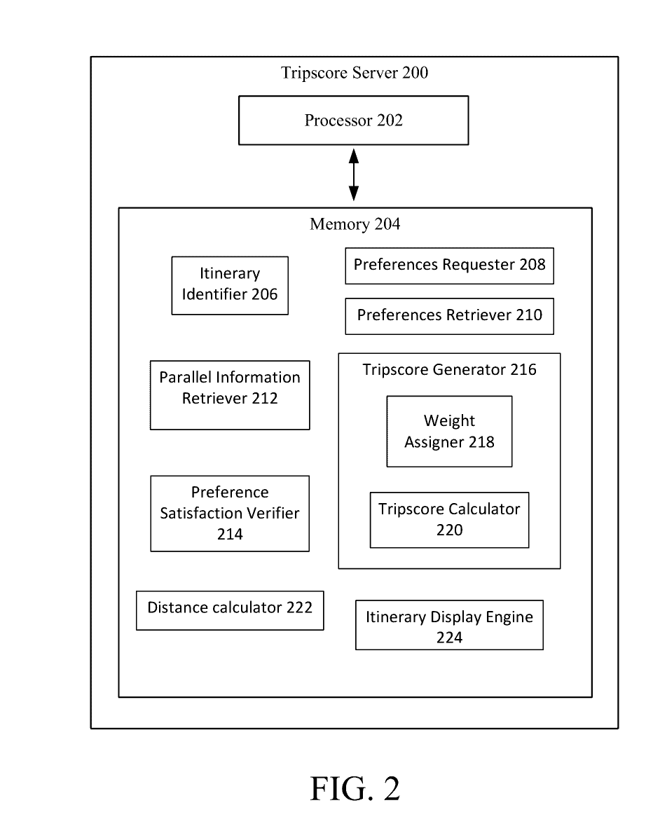

FIG. 1A depicts an example implementation of a graphical user interface (“GUI”) 100 for selecting a travel itinerary. The GUI 100 can display a list of travel itineraries 102, described in more detail below in reference to FIG. 2, and can include travel information such as TRIPSCORE 104, itinerary price 106, and airline 108 for each itinerary 102. The GUI 100 additionally allows a user to select an itinerary 102 using the select button 108. Selecting an itinerary 102 can cause a server to add the selected itinerary to a shopping cart, from which the itinerary 102 can later be purchased, or can cause the GUI 100 to present other options related to the itinerary 102. Other implementations can allow a user to purchase an itinerary 102 in any other appropriate manner. The travel itineraries 102 depicted in FIG. 1A can be ordered by TRIPSCORE 104, wherein the first listed itinerary 102 has a highest trip score of 79 and is displayed by the GUI 100 at the top of the list. If the list of itineraries 102 includes itineraries with equal TRIPSCORES 104, a tiebreaking procedure or algorithm can be employed to determine which itinerary to display first. By displaying an itinerary with a highest TRIPSCORE at the top of the list of itineraries, the GUI 100 can save time for a travel inquirer and can provide the travel inquirer with information and/or booking opportunities most relevant to their desires.

FIG. 1B depicts an example implementation of a GUI 120 for ranking preferences 122 and for selecting preference options. The GUI 120 can include a save button 124 and an options button 124. The preferences 122 can be initially displayed in or by GUI 120 in a predetermined ranked order. For example, the GUI 120 can initially display nine preferences in ranked order, such as: (1) preferred airline/frequent flyer program, (2) miles/points type, (3) prefer/avoid redeye flights, (4) refundable flights, (5) layover duration, (6) fewest connections, (7) type of aircraft, (8) lowest cost itinerary, and (9) Wi-Fi onboard aircraft. The GUI 120 can allow the preferences to be reordered via interaction with the GUI 120. For example, the GUI 120 can be incorporated with or displayed on a webpage, the predetermined preferences can be displayed in a descending ranked order, with the highest ranked preference positioned highest on the webpage and a next highest ranked preference positioned below the highest ranked preference, and the GUI 120 can allow a user to click and drag the predetermined preferences to reorder them. In other implementations, the GUI 120 allows for ranking of preferences in other ways. The GUI 120 can also allow a user to save or to submit the preference information, such as via a “save” or “submit” button 124, that can cause a server to store the information in a data store and to associate the saved preference information with a user account or a user account identifier.

In some implementations, the GUI 120 can include an options button 126 that, when clicked, can allow a user to indicate additional options, such as a preferred range of some parameter (e.g. a preferred price range for a trip). In at least one implementation, the options button 126 can, when clicked, allow a user to indicate binary preferences, such as a preference for redeye travel or for non-redeye travel. In another implementation, the options button 126 can, when clicked, allow a user to select a preferences from a drop-down list, such as selecting a preferred airline from a drop-down list of airlines. Selecting any such option may herein be referred to as selecting one or more preferences.

Referring now to FIG. 2, FIG. 2 depicts an example implementation of a TRIPSCORE server 200 for generating a TRIPSCORE. The TRIPSCORE server 200 can comprise a processor 202 and a memory 204. The memory 204 can include one or more digital memory devices, such as read-only memory (ROM), random-access memory (RAM), Electrically Erasable Programmable Read-Only Memory (EEPROM), erasable programmable read only memory (EPROM), or flash memory devices. The processor 202 can be configured to execute instructions stored in the memory 204 to perform one or more operations described herein. The memory 204 can store one or more applications, services, routines, servers, daemons, or other executable logics for generating a TRIPSCORE. The applications, services, routines, servers, daemons, or other executable logics stored in the memory 204 can include any of an itinerary identifier 206, a preferences requester 208, a preferences retriever 210, a parallel information retriever 212, a preference satisfaction verifier 214, a TRIPSCORE generator 216, a weight assigner 218, a TRIPSCORE calculator 220, a distance calculator 222, and an itinerary display engine 224.

In some implementations, the TRIPSCORE server 200 can comprise the itinerary identifier 206. The itinerary identifier 206 can include one or more applications, services, routines, servers, daemons, or other executable logics for identifying an itinerary based on trip information. In some implementations, the TRIPSCORE server 200 can receive a search request. The search request can be received via a network, such as a local area network (LAN), a wide area network (WAN), the internet, an intranet, a wireless link, or any combination thereof. The search request can comprise trip information, such as airport information, travel date information, travel time information, service class information, trip overview information (e.g. a round-trip, one way trip, or multicity trip preference), and passenger information (such as a number of passengers, an age of a passenger, or a citizenship of a passenger).

The itinerary identifier 206 can identify travel itineraries that correspond to the trip information. The preference satisfaction verifier 214 can determine or calculate search specific information (“SSI”) based on the trip information. For example, the preference satisfaction verifier 214 can calculate any of: a minimum fare, a minimum number of stops, a minimum layover time, a minimum total flying time, a maximum fare, a maximum number of stops, a maximum layover time, a maximum total flying time, a maximum miles earned, and a minimum miles earned, that correspond to the search query, and can filter for itineraries that correspond to the SSI. For example, the itinerary identifier 206 can retrieve corresponding travel itineraries from a data store, which can be local to the TRIPSCORE server 200 or can be accessible to the TRIPSCORE server 200 via, for example, a networks such as any of the networks described above. The itinerary identifier 206 can also request corresponding travel itineraries from one or more other servers. As used herein, the term “itinerary” can refer to any information that relates to trip information, such as, for example, a flight number, an airline, a flight time, a departure airport, an arrival airport, a connection airport, bus or shuttle stop or connection information, lodging information, ground transportation information, total miles travelled, total miles travelled by air, total miles travelled on a particular airline or airlines, flight time information including departure and/or arrival times, flight Wi-Fi availability information, loyalty program or frequent flyer information, or any other trip information, including any information described herein. An itinerary can, in some implementations, comprise parameter values for parameters related to trip information.

By way of example, in some implementations, the itinerary identifier 206 can receive a search request from a travel inquirer. The search request can include trip information that comprises an airport, a flight departure date, and a flight return date, and a one-way or round-trip preference. The itinerary identifier 206 can, responsive to receiving the search request, request corresponding flight information from another server, and can receive the corresponding flight information for one or more flights. Information related to each flight can be stored in a data store on the TRIPSCORE server 200 as an itinerary.

In some implementations, the TRIPSCORE server 200 can comprise the preferences requester 208. The preferences requester 208 can include one or more applications, services, routines, servers, daemons, or other executable logics for requesting and/or acquiring preference information. Requesting and/or acquiring preference information can include requesting a ranking of preferences relative to each other, which can indicate an order of importance of the preferences, and can include requesting preferred ranges of some parameter, such as a preferred price range for a trip, and can further include requesting binary preferences, such as a preference for redeye travel or for non-redeye travel, and can yet further include acquiring preferences from a list, such as selecting a preferred airline from a drop-down list of airlines. The preferences requester 208 can transmit to a client device a request for preference information, and can store any received responses in a data store on or accessible to the TRIPSCORE server 200. The transmitting a request for preference information can be performed responsive to the TRIPSCORE server 200 receiving a search request from the client device. In some implementations, the request for preferences can be GUI information that, when executed, causes to be displayed a GUI 120. As described above in reference to FIG. 1B, the GUI 120 can be an interactive object that displays a predetermined number of predetermined preferences in a predetermined ranked order. For example, the GUI 120 can display four predetermined preferences in a ranked order, or any other number of predetermined preferences. The GUI 120 can allow the preferences to be reordered via interaction with the GUI 120. For example, the GUI 120 can be incorporated with or displayed on a webpage, the predetermined preferences can be displayed in a descending ranked order, with the highest ranked preference positioned highest on the webpage and a next highest ranked preference positioned below the highest ranked preference, and the GUI 120 can allow a user to click and drag the predetermined preferences to reorder them. In other implementations, the GUI 120 allows for ranking of preferences in other ways. The GUI 120 can also allow a user to save or to submit the preference information, such as via a “save” or “submit” button, that can cause the preferences requester 208 to store the information in a data store. In some implementations, preferences requester 208 stores the information in a data store and associates the information with a user account.

In some implementations, the GUI 120 may additionally or alternatively include an “options” or “additional options” button that, when clicked, allows a user to indicate additional options, such as a preferred range of some parameter, such as a preferred price range for a trip, to indicate binary preferences, such as a preference for redeye travel or for non-redeye travel, or to indicate drop-down preferences from a drop-down list, such as selecting a preferred airline from a drop-down list of airlines.

In some implementations, as described above, the preferences requester 208 can transmit to the client device the request for preference information responsive to the TRIPSCORE server 200 receiving a search request from the client device. In other implementations, the preferences requester 208 can transmit to the client device the request for preference information responsive to receiving a preferences update request from the client device. For example, the client device may log in to a user account associated with an account identifier and may request permission to configure user preferences in the account. This may be done independent of a search request. The preferences requester 208 can receive a corresponding preferences configuration request from the client device, the preferences configuration request including the account identifier. The preferences requester 208 can, responsive to receiving the preferences configuration request, transmit to the client device a request for preferences. As described above in reference to responding to a search request, in some implementations, the request for preferences can be GUI information that, when executed, causes to be displayed a GUI 120. The GUI 120 can display an interactive object including a predetermined number of predetermined preferences in a predetermined ranked order. For example, the GUI 120 can display a ranking of preferences based on user account information associated with the account identifier, and the preferences can include preselected options, such as the options described above, associated with the user account information. Similarly to the GUI 120 described above in reference to responding to a search request, the GUI 120 can allow a user transmit to the TRIPSCORE server 200 preference information related to ay of changing a ranked order of preferences, indicating new preference information, or indicating options information. The preferences requester 208 can store the preferences information in a data store and can associate the preferences information with the user account, responsive to receiving the preferences information.

In some implementations, the TRIPSCORE server 200 can comprise the preferences retriever 210. The preferences retriever 210 can include one or more applications, services, routines, servers, daemons, or other executable logics for retrieving one or more preferences related to travel and for retrieving rankings of preferences related to travel from a data store. In some implementations, the preferences or rankings of preferences can correspond to a predefined set of preferences or a predefined ranking of preferences. For example, the preferences can correspond to a predefined set of preferences that include: an aircraft preference, a flexibility preference, a Wi-fi preference (e.g. a preference that an aircraft have Wi-fi available in-flight), an airline preference, a flight connection preference, a frequent flyer mile preference, a redeye preference (e.g. a preference for redeye flights, or a preference for non-redeye flights), a flight layover preference (which can include a preferred range of total layover time), a price preference (which can include a preferred price range), a total travel time preference (which can include a range of acceptable total travel times), or any other appropriate preference. The preferences can also be ranked, such as, for example, ranked in order of importance to a user. In some implementations, the preferences can be ranked in a default ranking.

In some implementations, the preferences retriever 210 can retrieve user preferences or rankings of preferences associated with a user account, or can retrieve default preferences or default rankings of preferences stored in a data store, or any combination of the two. The preferences retriever 210 can retrieve preferences or rankings of preferences corresponding to a complete set of the predefined preferences. In some implementations, the search request received by the TRIPSCORE server 200 can include an account identifier, and the preferences retriever 210 can retrieve user preferences or rankings of preferences stored in a data store that correspond to the account identifier, and can further retrieve default preferences or default rankings of preferences for any preferences for which there is no stored user preference, thus retrieving a complete set of the predefined preferences. The preferences retriever 210 can also retrieve default preference options, such as, for example, a default preference to avoid redeye flights. In other implementations, the search request does not include an account identifier, and the preferences retriever can retrieve the complete set of one or more default preferences or rankings of preferences from a data store.

In some implementations, the TRIPSCORE server 200 includes the parallel information retriever 212. The parallel information retriever 212 can include one or more applications, services, routines, servers, daemons, or other executable logics for retrieving information that can be used in a TRIPSCORE calculation in parallel with other processes described herein. In some implementations, the parallel information retriever can retrieve information that may take more time to retrieve than, for example, the time required to retrieve preferences or rankings of preferences from the data store on or accessible to TRIPSCORE server 200. For example, the parallel information retrieve can retrieve information related to a loyalty program or to frequent flyer miles, which in some cases can include requesting loyalty program or frequent flyer mile data from a third party. The parallel information retriever 212 can determine that one or more preferences to be included in a TRIPSCORE calculation relate to parallel information. The parallel information retriever 212 can, responsive to that determination, transmit a request for parallel information to a server other than the TRIPSCORE 200 server, such as, for example, a third party server (e.g. can transmit a request to identify a number of available loyalty points or frequent flyer miles to a server related to a loyalty program or frequent flyer miles program). The parallel information retriever 212 can perform at least one of these processes in parallel with other processes performed by the TRIPSCORE server 200. For example, the preference satisfaction verifier 214, described in more detail below, can perform processes for verifying whether a preference is satisfied by an itinerary related to preferences that are not associated with parallel information, such as, for example, verifying whether an itinerary satisfies a preference for redeye flights. The parallel information retriever 212 can, in parallel with the preference satisfaction verifier 214 performing those processes, retrieve parallel information. In some implementations, subsequent to the parallel information retriever 212 retrieving parallel information, the preference satisfaction verifier 214 can perform processes for verifying whether a preference is satisfied by an itinerary related to preferences that are associated with parallel information, such as, for example, verifying whether an itinerary satisfies a frequent flyer mile preference. Performing these processes in parallel shortens the amount of time required to calculate a TRIPSCORE, enabling a TRIPSCORE server to advantageously calculate a TRIPSCORE more quickly.

In some implementations, the TRIPSCORE server 200 includes the preference satisfaction verifier 214. The preference satisfaction verifier 214 can include one or more applications, services, routines, servers, daemons, or other executable logics for verifying whether an itinerary satisfies a preference. Verifying whether an itinerary satisfies a preference can include determining that an itinerary does satisfy a preference, determining that an itinerary does not satisfy a preference, determining that an itinerary has a particular likelihood of satisfying a preference, determining that an itinerary has a satisfaction score corresponding to an extent to which the itinerary satisfies a preference, or any combination of these verification methods, results or outputs.

The preference satisfaction verifier 214 can further access an itinerary identified by itinerary identifier 206, and can compare the itinerary to the SSI, or to a preference stored on or accessible to tripscore server 200, such as a preference retrieved by preferences retriever 210. An itinerary can, in some implementations, comprise parameter values for parameters related to trip information. The preference satisfaction verifier 214 can verify whether parameter values of an itinerary correspond to preference parameters. For example, if a preference parameter indicates a preference for in-flight Wi-Fi, the preference satisfaction verifier 214 can verify whether the itinerary includes an indication of in-flight Wi-Fi for one or each of the flights of the itinerary. If the preference satisfaction verifier 214 determines that the itinerary does include an indication of in-flight Wi-Fi for one or each of the flights of the itinerary, the preference satisfaction verifier 214 can output an indication that the itinerary satisfies the in-flight Wi-Fi preference. If the preference satisfaction verifier 214 determines that the itinerary does not include any indication of in-flight Wi-Fi for any of the flights of the itinerary, the preference satisfaction verifier 214 can output an indication that the itinerary does not satisfy the in-flight Wi-Fi preference. The preference satisfaction verifier 214 can output a binary indication that the itinerary does or does not satisfy the preference. In some implementations, the preference satisfaction verifier 214 can verify, for each itinerary identified by the itinerary identifier 206 for each preference retrieved by preference retriever 210, whether the itinerary satisfies the preference.

In some implementations, the tripscore server 200 includes the tripscore generator 216. The tripscore generator 216 can include one or more applications, services, routines, servers, daemons, or other executable logics for generating a TRIPSCORE. The TRIPSCORE generator 216 can include the weight assigner 218 and the TRIPSCORE calculator 220.

In some implementations, the weight assigner 218 can include one or more applications, services, routines, servers, daemons, or other executable logics for assigning weights or weight points to preferences. The weight assigner 218 can assign weights to a predetermined list of preferences. In some implementations, the predetermined list of preference can include a subset of ranked preferences for which the preference retriever 212 has retrieved a ranking of preferences, and a subset of unranked preferences that includes the remaining unranked preferences of the predetermined list of preferences. In some implementations, all of the preferences of the predetermined list of preferences are ranked, and the subset of ranked preferences includes all of the preferences in the predetermined list of preferences. In other implementations, none of the preferences of the predetermined list of preferences are ranked, and the subset of unranked preferences includes all of the preferences in the predetermined list of preferences.

The weight assigner 218 can assign weights to preferences of the ranked subset of preferences based on the ranking of preferences retrieved by the preference retriever 212, and can assign weights to preferences of the unranked subset of preferences based on a default weight assigning algorithm. For example, the weight assigner 218 can distribute a predetermined number of weight points to the preferences of the predetermined list of preferences. The weight assigner 218 can assigned weight points to the ranked subset of preferences assigned based on the ranking of preferences, and can evenly assign any remaining weight points of the predetermined number of weight points to the preferences of the unranked subset.

In one implementation, the weight assigner 218 can assign a number of weight points equal to:

$${\sum }_{n = 1}^{N} n$$

where N is a number of preferences in the predetermined list of preferences. For example, the predetermined number of preferences can include ten preferences labeled A through J. Preferences B, C, D and E can be ranked, with preference B being ranked highest, followed by preference C, followed by preference D, followed by preference E, and preferences A, F, G, H, I, J can be unranked. The weight assigner 218 can assign a total of 10+9+8+ . . . +2+1=55 weight points to the preferences. The weight assigner 218 can assign weight points to the ranked subset of preferences (preferences B, C, D, and E) based on the ranking of preferences. In some implementations, the weight assigner 218 can assign to each ranked preference a number of points equal to the total number of preferences in the predetermined list of preferences less the rank number of the ranked preference, plus one. Thus preference B, which is the highest ranked preference with a rank of 1, can be assigned 10 weight points (10−1+1). Preference C, which has a rank of 2, can be assigned 9 weight points (10−2+1), and so for each of the ranked preferences. The result of this assignment of weight points if that preference B is assigned 10 weight points, preference C is assigned 9 weight points, preference D is assigned 8 weight points, and preference E is assigned 7 weight points. Any remaining weight points of the predetermined number of weight points can be evenly assigned to the unranked preferences. Thus, the remaining 21 weight points can be evenly assigned to preferences A, F, G, H, I, J, such that each unranked preference is assigned 3.5 weight points. In other implementations, weights can be assigned in any other appropriate manner, including by assigning a default number of weight points to one or more unranked preferences.

In other implementations, the preference retriever 210 can retrieve a default set of rankings, can determine default relative rankings of any unranked preferences based on the default set of rankings, and the weight assigner 218 can assigned weight points to the unranked preferences based on the default relative rankings. Continuing the above example, if preferences A, F, G, H, I and J are unranked, the preferences retriever 210 can retrieve a default ranking of preferences that includes preferences A, F, G, H, I and J. The preferences retriever 210 can determine a relative ranking for preferences A, F, G, H, I and J based on the default ranking, and weight assigner 218 can assigned weight points to preferences A, F, G, H, I and J based on the determined relative ranking. For example, the preferences retriever 210 can assign each of preferences A, F, G, H, I and J a rank based on the determined relative ranking that is lower than the rank of any ranked preference, and the weight assigner 218 can assign weight points equal to the total number of preferences in the predetermined list of preferences less the rank number of the preference, plus one. In other words, after assigning ranks to A, F, G, H, I and J, the weight assigner 218 can continue to use the same formula that used to assign weight points to the ranked preferences to assign weight points to A, F, G, H, I and J.

In some implementations, the TRIPSCORE calculator 220 can include one or more applications, services, routines, servers, daemons, or other executable logics for calculating a trip score for an itinerary. The TRIPSCORE calculator 220 can calculate a TRIPSCORE for an itinerary identified by itinerary identifier 206 based on the weight points assigned to preferences of a predetermined list of preferences by the weight assigner 218, and further based on outputs of the preference satisfaction verifier 214 that indicate whether the itinerary does or does not satisfy the predetermined preferences. In an implementation, the TRIPSCORE calculator 220 can calculate a TRIPSCORE for an itinerary by (i) initializing a TRIPSCORE to 0, (ii) identifying, for each preference of a predetermined list of preferences based on outputs of the preference satisfaction verifier, whether the itinerary satisfies the preference, and assigning a 1 (or other number) to a preference satisfaction score if the preference is satisfied by the itinerary and assigning a 0 to the preference satisfaction score if the preference is not satisfied by the itinerary, (iii) multiplying the preference satisfaction score by the number of weight points assigned to the preference to generate a total preference contribution, and (iv) adding the total preference contribution to the TRIPSCORE.

In some implementations, the TRIPSCORE server 200 can include a distance calculator 222. The distance calculator 222 can include one or more applications, services, routines, servers, daemons, or other executable logics for calculating a distance that corresponds to an itinerary or to a flight. For example, the distance calculator 222 can include an application program interface, or a plug-in for a web browser, that determines a number of miles that correspond to an itinerary. This can be used, for example, to determine who many frequent flyer miles an itinerary may earn, or can be used to determine how many frequent flyer miles would be required to purchase an itinerary.

In some implementations, the TRIPSCORE server 200 can include itinerary display engine 224. The itinerary display engine 224 can include one or more applications, services, routines, servers, daemons, or other executable logics for displaying an itinerary. For example, the itinerary display engine can transmit information related to a GUI 100 that displays itinerary information. As described above in reference to FIG. 1A, the GUI 100 can display a list itineraries ordered by TRIPSCORE, and can further include options related to the itineraries, such as an option to purchase an itinerary or an option to request more details about an itinerary.

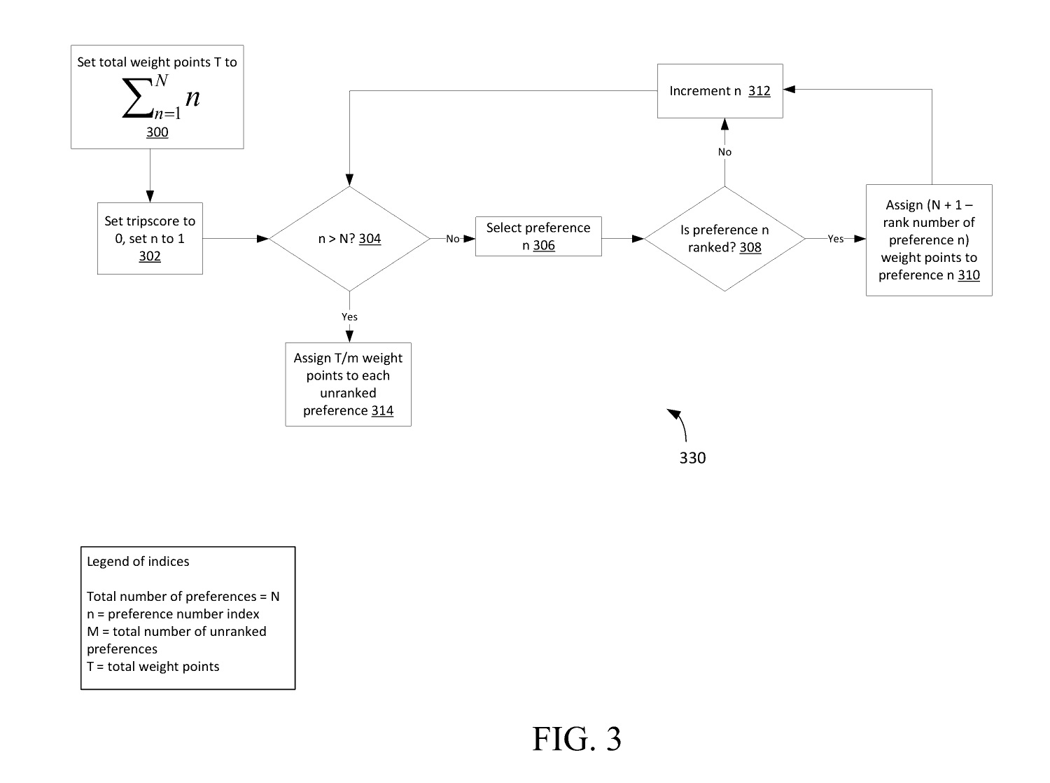

Referring now to FIG. 3, FIG. 3 depicts an example implementation of a method 330 for assigning weight points to a predetermined list of preferences. The predetermined list of preferences can include ranked preferences and unranked preferences, and can be retrieved from a data store, or can be received from the preferences retriever 210. A ranking of at least some of the preferences of the predetermined list of preferences can be a separate data file from the predetermined list of preferences, or all of the preferences of the predetermined list of preferences can be associated with a rank number, and in some cases, any unranked preference can be assigned a dummy rank number that indicates that the preference is unranked.

In some implementations, the method 330 can include steps 300-314. At step 300, the weight assigner 218 can set a total number of weight points T to be equal to:

$${\sum }_{n = 1}^{N} n$$

where N is a number of preferences in the predetermined list of preferences. At step 302, the weight assigner 218 can initialize a TRIPSCORE to 0, the index n to 1, and the index m to 0. At step 304, the weight assigner 218 can determine whether n>N. If n>N, the method can proceed to step 314, and the weight assigner 218 can assign a number of weight points equal to T/M to each unranked preference, and the method can end. If n is not greater than N, the method can proceed to step 306, where the weight assigner 218 can select preference n. At step 308, the weight assigner 218 can determine whether preference n is a ranked preference. If weight assigner 218 determines that n is a ranked preference, the method can proceed to step 310, and weight assigner 218 can assign a number of weight points equal to (N+1—rank number of preference n) to preference n. The method can then proceed to step 312. Returning to step 308, if weight assigner 218 determines that n is not a ranked preference, the method can proceed to step 312. At step 312, the weight assigner 218 can increment n, and the method can proceed to step 304.

Referring to FIG. 3 in more detail, in some implementations, at step 300, the weight assigner 218 can set a total number of weight points T to be equal to Σₙ₌₁^{N} n. In other implementations, the weight assigner 218 can set the total number of weight points to be equal to some other number. The total number of weight points can be set based on a number of preferences of the predetermined list of preferences that are ranked, such that, once points are assigned to ranked preferences, each of the unranked preferences is assigned a lower number of weight points than each of the ranked preferences is assigned. The weight assigner 218 can then proceed to step 302.

In some implementations, at step 302, the weight assigner 218 can initialize a TRIPSCORE to 0, and can initialize an index n to 1. The weight assigner 218 can then proceed to step 304. At step 304, the weight assigner 218 can compare the index value n to the total number of preferences in the predefined list of preferences N. Comparing the index value n to the total number of preferences in the predefined list of preferences N may comprise a bitwise comparison of data strings (e.g. an XOR with a result of 0 indicating the index is equal to the threshold); calculating a difference between the index value n to the total number of preferences in the predefined list of preferences N and determining if the result is negative, positive, or zero; or any other such method. This can help determine whether every ranked preference of the predetermined list of preferences has been assigned weight points. If the index value n is greater than N, weight assigner 218 can proceed to step 314. Otherwise, weight assigner 218 can proceed to step 306.

In some implementations, at step 306, the weight assigner 218 can select a preference n (the nth preference from the predetermined list of preferences) and can proceed to step 308. At step 308, the weight assigner 218 can determine whether the preference n is ranked. For example, as explained above, the weight assigner 218 can retrieve the predetermined list of preferences from a data store, or can receive the predetermined list of preferences from the preferences retriever 210. A ranking of at least some of the preferences of the predetermined list of preferences can be retrieved or received as a separate data file from the predetermined list of preferences, or all of the preferences of the predetermined list of preferences can be associated with a rank number, and in some cases, any unranked preference can be assigned a dummy rank number that indicates that the preference is unranked. The weight assigner 218 can verify whether preference n is ranked by, for example, verifying whether preference n is included in the ranking of at least some of the preferences, or whether the preference n is associated with a non-dummy rank number. If the weight assigner 218 determines that preference n is ranked, the weight assigner 218 can proceed to step 310. If the weight assigner 218 determines that preference n is not ranked, weight assigner 218 can proceed to step 312.

In some implementations, at step 310, the weight assigner 218 can assign weight points to a ranked preference n based on its rank. For example, the weight assigner 218 can assign (N+1—rank number) weight points to preference n. In other implementations, weight assigner 218 can assign a different number of weight points. The weight assigner 218 can assign the weight points to ranked preferences such that the any preference ranked higher than another preference is assigned more weight points than the other preference. The weight assigner 218 can proceed to step 312 after assigning weight points to the ranked preference.

In some implementations, at step 312, the weight assigner 218 can increment index n. The index n can be used to count how many preferences in the predetermined list of preferences have been processed by method 330. After incrementing n, the weight assigner 218 can proceed to step 304. At step 304, the weight assigner 218 can compare the index value n to the total number of preferences in the predefined list of preferences N, as described above. If the index value n is greater than N, weight assigner 218 can proceed to step 314.

In some implementations, at step 314, the weight assigner 218 can assign weight points to each unranked preference of the predetermined list of preferences. For example, the weight assigner 218 can assign T/M number of weight points to each unranked preference. In other words, after assigning weight points to any ranked preferences, any remaining weight points of the total number of weight points T can be evenly distributed to the unranked preferences. In other implementations, there are no ranked preferences in the predetermined list of preferences, and the weight assigner 218 can evenly distribute the weight points T among the unranked preferences.

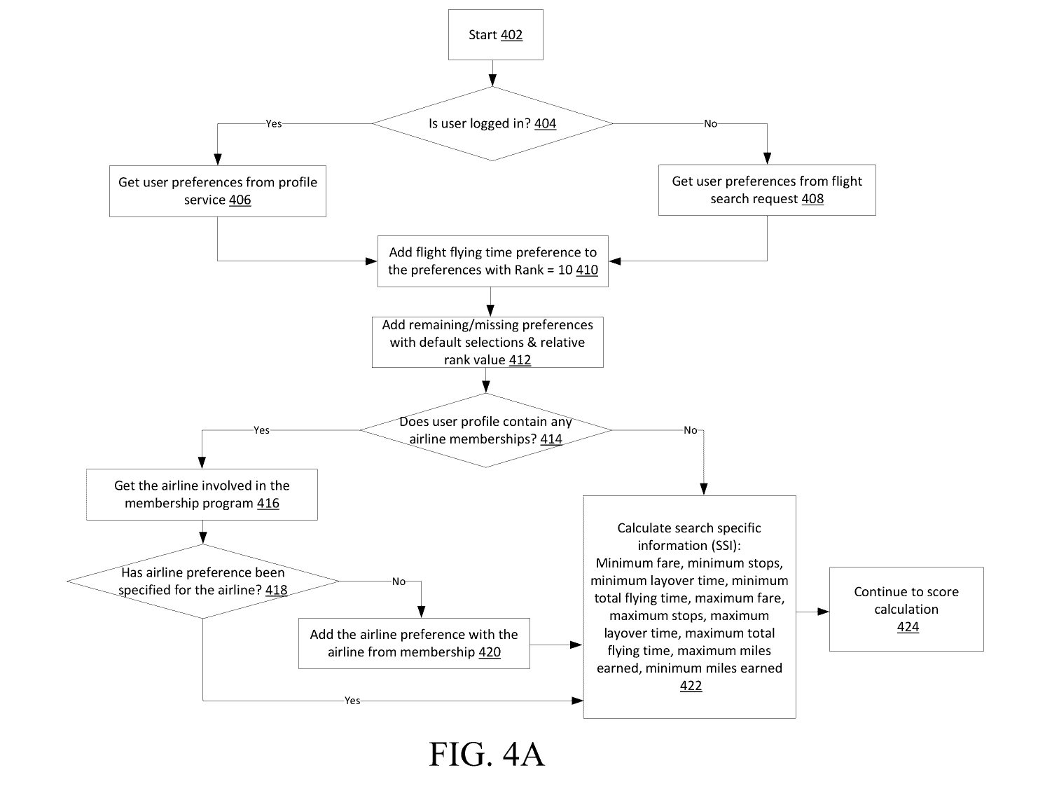

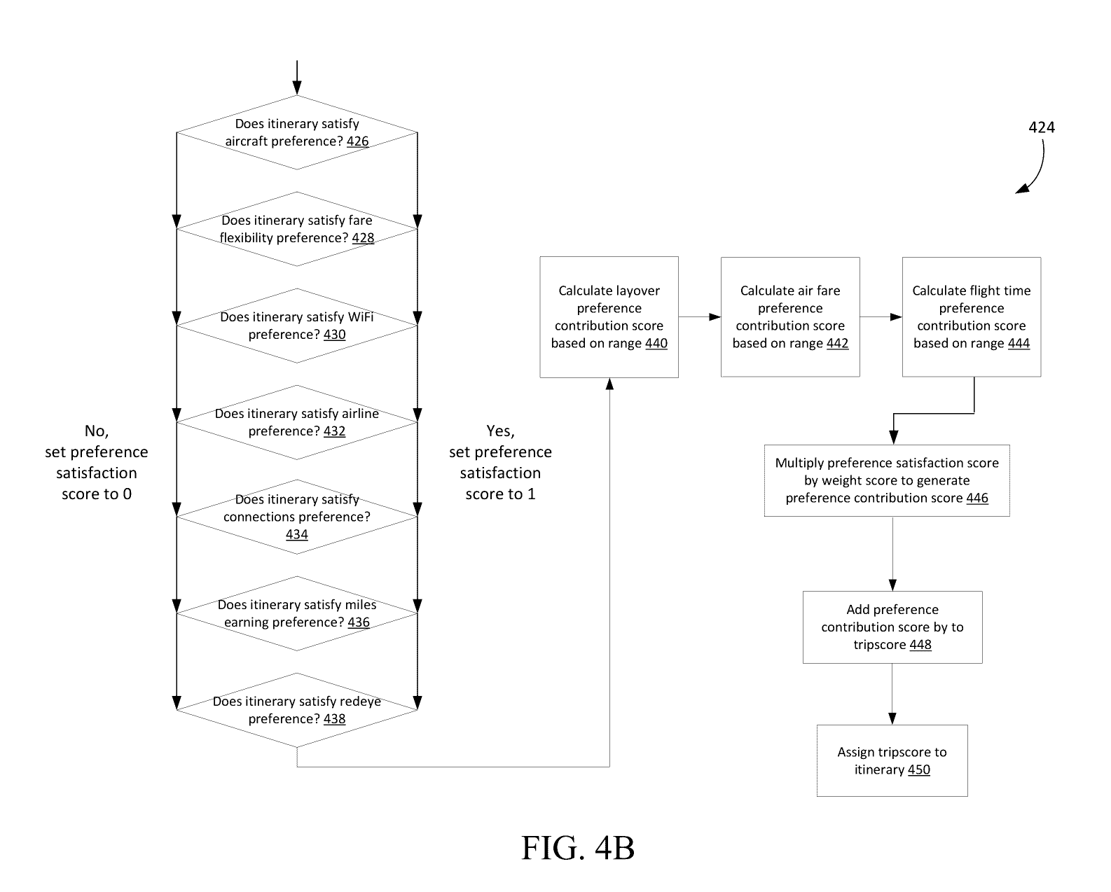

Referring now to FIGS. 4A and 4B in general, FIG. 4A and 4B depict an overview of an example implementation of a method 400 for generating a TRIPSCORE for an itinerary. In method 400, one or more TRIPSCORE servers can retrieve the flight search response and user preferences. The one or more servers can then send airfare information to a parallel server or to a third party system, which can send back, for example, calculated frequent flyer mile data. Based on, for example, user defined preferences and mileage data, the one or more servers can calculate a TRIPSCORE for each itinerary. Finally, the one or more servers can present each itinerary sorted by the relevant TRIPSCORE, and can present the mileage and general travel details for each itinerary.

In some implementations, the method 400 can include steps 402 through 456. At step 402, the TRIPSCORE server 200 can initiate the method 400 responsive to, for example, receiving a search query from a client device, and can proceed to step 404. At step 404, the TRIPSCORE 200 server can determine if a user is logged in, such as, for example, by determining if the search query included an account identifier. If the TRIPSCORE server determines that a user is logged in, the TRIPSCORE server 200 can proceed to step 406, where the preferences retriever 210 can retrieve preferences associated with the account identifier, and the TRIPSCORE server 200 can proceed to step 410. Returning to step 404, if the TRIPSCORE server determines that no user is logged in, the TRIPSCORE server 200 can proceed to step 408, where the preferences requester 208 can transmit a request for preference information to the client device, or to a webpage accessible to the client device, or in any other appropriate manner, such as any manner described above in reference to FIG. 2. The preferences requester can then receive and store the preference information, and can proceed to step 410.

In some implementations, at step 410, preferences retriever 210 can assign a rank to an additional preference not included in any preferences associated with a user account and retrieved by preferences retriever 210 at step 406, and not associated with any preferences requested or received by the preferences requester 208 at step 408. For example, the preferences retriever 210 can assign a highest rank to a total flight time preference. This can be useful, for example, when it is assumed that a total flight time preference is generally of most important to users of a system for generating a TRIPSCORE. In some implementations, at step 410, the preferences retriever can add the additional preference to a ranking of preferences as the highest ranked preference, or can add the additional preference to a list of unranked preferences as the highest, and only, ranked preference. In other implementations, the additional preference may have been included in preferences associated with a user account or may have been requested or received by the preferences requester 208, but the preferences retriever 210 can override any ranking of the additional preference included in any of those preferences and can assign a highest rank to the additional preference, or can increment the rank of the additional preference by e.g. a predetermined number of ranks. The preferences retriever 210 can then proceed to step 412.

In some implementations, at step 412, the preferences retriever 210 can retrieve one or more default preferences, default preference options, and/or default rankings to fill out ranking of a predetermined list of preferences. Some of the preferences of the predetermined list of preferences may have been retrieved in step 406 or 408 by the preference retriever 210. At step 412, the preference retriever 210 can retrieve preferences of the predetermined list of preferences not yet retrieved in step 406 or 408 from a default list of preferences. The default list of preference can include default preference options, such as, for example, a preference to avoid redeye flights. The default list of preferences can also include a default ranking of preferences, and the preferences retriever 210 can assign a rank to any unranked preference of the predetermined list of preferences in any appropriate manner, such as any manner described above in reference to FIG. 2. The preference retriever 210 can then proceed to step 414.

In some implementations, at step 414, the preferences retriever 210 can determine whether a user profile or user account corresponding to the search query received at step 400 is associated with airline membership information. For example, the preferences retriever 210 can determine whether the user profile indicates that the user is enrolled in a frequent flyer program for a particular airline. If the preferences retriever 210 determines that there is no airline membership information associated with the user account, or determines that no user account was associated with the search query, the preferences retriever 210 can proceed to step 422. Otherwise, the preferences retriever 210 can proceed to steps 416-420.

In some implementations, at step 416, the preferences retriever 210 can determine which airline is associated with the user account, and can proceed to step 418. At step 418, the preferences retriever 210 can determine whether an airline preference has been specified for a particular airline, e.g. whether the preferences retriever 210 has retrieved a preference that includes an option specifying a particular airline. If the preferences retriever 210 determines that no particular airline has been specified, the preferences retriever 210 can proceed to step 420, can specify a preference for any airline associated with the user account, and can then proceed to step 422. Returning to step 418, if the preferences retriever 210 determines that a particular airline has been specified, the preferences retriever 210 can proceed directly to step 422.

In some implementations, at step 422, the preferences retriever 210 can determine or calculate search specific information based on the search query. For example, the TRIPSCORE server 200 can calculate any of: a minimum fare, a minimum number of stops, a minimum layover time, a minimum total flying time, a maximum fare, a maximum number of stops, a maximum layover time, a maximum total flying time, a maximum miles earned, and a minimum miles earned, that correspond to the search query. This information can be stored by the preferences retriever 210 as preference information, or can be used by the itinerary identifier 206 to filter for itineraries that correspond to the trip information. The TRIPSCORE server 200 can then proceed to TRIPSCORE generation or TRIPSCORE calculation, which is described fellow in reference to FIG. 4B.

FIG. 4B describes an implementation method 424 for generating a TRIPSCORE for an itinerary. FIG. 4B depicts the preference satisfaction verifier 214 calculating, for the itinerary, preference contribution scores based on binary preference satisfaction in steps 426-438, and depicts the preference satisfaction verifier 214 calculating preference contribution scores based on range preference satisfaction in steps 440-444. At step 446, the TRIPSCORE calculator 220 can multiply preference satisfaction scores by corresponding weight scores, and at step 448 the TRIPSCORE calculator 220 can add preference contribution scores to generate a total TRIPSCORE for the itinerary. At step 450 the TRIPSCORE calculator 220 can assign the total TRIPSCORE to the itinerary. These steps need not be performed in sequential order. For example, any preference satisfaction score for any preference can be calculated in any order, or in parallel. The method 424 can be repeated for a plurality of itineraries.

In some implementations, at steps 426-440, the preference satisfaction verifier 214 can determine whether a number of binary preferences are satisfied by an itinerary. A binary preference can be a preference that is either satisfied or not, as determined by, for example, the preference satisfaction verifier 214.

In some implementations, at step 426, the preference satisfaction verifier 214 can determine whether the itinerary corresponds to a preferred aircraft. If the itinerary does not correspond to the preferred aircraft, the preference satisfaction verifier 214 sets a preference satisfaction score for the aircraft preference to 0. If the itinerary does correspond to the preferred aircraft, the preference satisfaction verifier 214 sets the preference satisfaction score for the aircraft preference to 1. The preference satisfaction verifier 214 can then proceed to step 428.

In some implementations, at step 428, the preference satisfaction verifier 214 can determine whether the itinerary corresponds to a fare flexibility preference. If the itinerary does not satisfy the fare flexibility preference, the preference satisfaction verifier 214 sets a preference satisfaction score for the fare flexibility preference to 0. If the itinerary does satisfy the fare flexibility preference, the preference satisfaction verifier 214 sets the satisfaction score for the fare flexibility preference to 1. The preference satisfaction verifier 214 can then proceed to step 430.

In some implementations, at step 430, the preference satisfaction verifier 214 can determine whether the itinerary corresponds to a Wi-fi preference. If the itinerary does not satisfy the Wi-fi preference, the preference satisfaction verifier 214 sets a preference satisfaction score for the Wi-fi preference to 0. If the itinerary does satisfy the Wi-fi preference, the preference satisfaction verifier 214 sets the satisfaction score for the Wi-fi preference to 1. The preference satisfaction verifier 214 can then proceed to step 432.

In some implementations, at step 432, the preference satisfaction verifier 214 can determine whether the itinerary corresponds to an airline preference. If the itinerary does not satisfy the airline preference, the preference satisfaction verifier 214 sets a preference satisfaction score for the airline preference to 0. If the itinerary does satisfy the airline preference, the preference satisfaction verifier 214 sets the satisfaction score for the airline preference to 1. The preference satisfaction verifier 214 can then proceed to step 432.

In some implementations, at step 434, the preference satisfaction verifier 214 can determine whether the itinerary corresponds to a flight connections or stops preference. If the itinerary does not satisfy the flight connections or stops preference, the preference satisfaction verifier 214 sets a preference satisfaction score for the flight connections or stops preference to 0. If the itinerary does satisfy the flight connections or stops preference, the preference satisfaction verifier 214 sets the satisfaction score for the flight connections or stops preference to 1. The preference satisfaction verifier 214 can then proceed to step 436.

In some implementations, at step 436, the preference satisfaction verifier 214 can determine whether the itinerary corresponds to a miles earning preference. If the itinerary does not satisfy the miles earning preference, the preference satisfaction verifier 214 sets a preference satisfaction score for the miles earning preference to 0. If the itinerary does satisfy the miles earning preference, the preference satisfaction verifier 214 sets the satisfaction score for the miles earning preference to 1. The preference satisfaction verifier 214 can then proceed to step 438.

In some implementations, at step 438, the preference satisfaction verifier 214 can determine whether the itinerary corresponds to a redeye preference. If the itinerary does not satisfy the redeye preference, the preference satisfaction verifier 214 sets a preference satisfaction score for the redeye preference to 0. If the itinerary does satisfy the redeye preference, the preference satisfaction verifier 214 sets the satisfaction score for the redeye preference to 1. The preference satisfaction verifier 214 can then proceed to step 440.

In some implementations, at step 440, the preference satisfaction verifier 214 can calculate a layover preference contribution score based on whether the itinerary corresponds to a range of acceptable or preferred layover times. In some implementations, the range can be a range from zero to some positive number, i.e. can define a maximum acceptable or preferred layover time. In other implementations, the range can be from a non-zero number to a higher number, for example, can be 1-3 hours. If the itinerary does not satisfy the layover preference, the preference satisfaction verifier 214 sets a preference satisfaction score for the layover preference to 0. If the itinerary does satisfy the layover preference, the preference satisfaction verifier 214 sets the satisfaction score for the layover preference to 1.

In some implementations, at step 440, a layover preference is set as an option to prefer the lowest layover time. In those implementations, the preference satisfaction verifier 214 can set the satisfaction score to 1 for an itinerary that corresponds to a lowest layover time out of a plurality of itineraries retrieved by the itinerary identifier 206 that correspond to the flight information, and can otherwise set the satisfaction score to 0.

In some implementations, an air fare preference is assumed to be for a lowest layover time. In some implementations, at step 440, the preference satisfaction verifier 214 can set respective layover preference satisfaction scores for a plurality of itineraries to numbers in a range of 0 to 1. The preference satisfaction verifier 214 can set a satisfaction score for an itinerary having a lowest layover time of the plurality of itineraries (a “best” itinerary, in the layover context) to 1. For each of the other itineraries of the plurality of itineraries, the preference satisfaction verifier 214 can determine a metric that represents a deviation from the lowest layover time, and can set a satisfaction score that corresponds to that metric. For example, the preference satisfaction verifier 214 can calculate a standard deviation of the set of layover times corresponding to the plurality of itineraries. The preference satisfaction verifier 214 can then calculate, for an itinerary of the plurality of itineraries, a number S₁ of standard deviations by which the itinerary's layover time deviates from the best itinerary's layover time. The number S₁ may be a fractional or decimal number. The preference satisfaction verifier 214 can then set a satisfaction score to be equal to a number X₁=1−(C₁×S₁), where C₁ is some predetermined coefficient. In this way, the preference satisfaction verifier 214 can set a satisfaction score for a layover preference to 1 for a best itinerary, and can set a number in a range of 0 to 1 for each other itinerary of the plurality of itineraries. The more an itinerary's an itinerary's layover time differs from the best layover time, the lower the layover preference satisfaction score.

In some implementations, at step 442, the preference satisfaction verifier 214 can calculate an air fare preference contribution score based on whether the itinerary corresponds to a range of acceptable or preferred air fares. In some implementations, the range can be a range from zero to some positive number, i.e. can define a maximum acceptable or preferred air fare. If the itinerary does not satisfy the air fare preference, the preference satisfaction verifier 214 sets a preference satisfaction score for the air fare preference to 0. If the itinerary does satisfy the air fare preference, the preference satisfaction verifier 214 sets the satisfaction score for the air fare preference to 1.

In some implementations, an air fare preference is assumed to be for a lowest air fare. In some implementations, the preference satisfaction verifier 214 can set respective air fare preference satisfaction scores for a plurality of itineraries to numbers in a range of 0 to 1. The preference satisfaction verifier 214 can set a satisfaction score for an itinerary having a lowest air fare of the plurality of itineraries (a “best” itinerary, in the air fare) to 1. For each of the other itineraries of the plurality of itineraries, the preference satisfaction verifier 214 can determine a metric that represents a deviation from the lowest air fare, and can set a satisfaction score that corresponds to that metric. For example, the preference satisfaction verifier 214 can calculate a standard deviation of the set of air fares corresponding to the plurality of itineraries. The preference satisfaction verifier 214 can then calculate, for an itinerary of the plurality of itineraries, a number S₂ of standard deviations by which the itinerary's air fare deviates from the best itinerary's air fare. The number S₂ may be a fractional or decimal number. The preference satisfaction verifier 214 can then set a satisfaction score to be equal to a number X₂=1−(C₂×S₂), where C₂, where C₂ is some predetermined coefficient. In this way, the preference satisfaction verifier 214 can set a satisfaction score for an air fare preference to 1 for a best itinerary, and can set a number in a range of 0 to 1 for each other itinerary of the plurality of itineraries. The more an itinerary's air fare differs from the best air fare, the lower the layover preference satisfaction score.

In some implementations, at step 444, the preference satisfaction verifier 214 can calculate a flight time preference contribution score based on whether the itinerary corresponds to a range of acceptable or preferred flight times. In some implementations, the range can be a range from zero to some positive number, i.e. can define a maximum acceptable or preferred flight time. If the itinerary does not satisfy the flight time preference, the preference satisfaction verifier 214 sets a preference satisfaction score for the layover preference to 0. If the itinerary does satisfy the flight time preference, the preference satisfaction verifier 214 sets the satisfaction score for the flight time preference to 1.

In some implementations, a flight time preference is assumed to be for a lowest flight time. In some implementations, the preference satisfaction verifier 214 can set respective flight time preference satisfaction scores for a plurality of itineraries to numbers in a range of 0 to 1. The preference satisfaction verifier 214 can set a satisfaction score for an itinerary having a lowest flight time of the plurality of itineraries (a “best” itinerary, in the air fare) to 1. For each of the other itineraries of the plurality of itineraries, the preference satisfaction verifier 214 can determine a metric that represents a deviation from the lowest flight time, and can set a satisfaction score that corresponds to that metric. For example, the preference satisfaction verifier 214 can calculate a standard deviation of the set of flight times corresponding to the plurality of itineraries. The preference satisfaction verifier 214 can then calculate, for an itinerary of the plurality of itineraries, a number S₃ of standard deviations by which the itinerary's flight time deviates from the best itinerary's air fare. The number S₃ may be a fractional or decimal number. The preference satisfaction verifier 214 can then set a satisfaction score to be equal to a number X₃=1−(C₃×S₃), where C₃, where C₃ is some predetermined coefficient. In this way, the preference satisfaction verifier 214 can set a satisfaction score for a flight time preference to 1 for a best itinerary, and can set a number in a range of 0 to 1 for each other itinerary of the plurality of itineraries. The more an itinerary's flight time differs from the best air fare, the lower the layover preference satisfaction score.

In some implementations, at step 446, the TRIPSCORE calculator 220 can multiply the satisfaction score for each preference by a number of weight points assigned to the preference by the weight assigner 218 to generate a preference contribution score. The TRIPSCORE calculator 220 can then proceed to step 448 and can add the preference contribution score to a TRIPSCORE for the itinerary. As discussed above, steps 426-448 need not be performed in sequential order. For example, any preference satisfaction score for any preference can be calculated in any order, or in parallel. After completing step 448 for each of the preferences, the TRIPSCORE calculator 220 can proceed to step 450 and can assign the TRIPSCORE to the itinerary.

The above description of the methods depicted in FIGS. 4A and 4B refers to methods for calculating a TRIPSCORE for a flight itinerary using flight preferences. Similar methods can be used to calculate a TRIPSCORE for other itineraries, such as vehicle rental itineraries, hotel itineraries. For example, similar methods can be used in which vehicle rental itineraries and vehicle preferences are used, rather than flight itineraries and flight preferences, or lodging itineraries and lodging preferences can be used, rather than flight itineraries and flight preferences. Vehicle rental itineraries can include, for example, vehicle rental reservations, and vehicle preferences can be, for example, any of the preferences discussed above, such as a preferred vehicle class, a lowest cost preference, a rental pickup/drop-off proximity to an airport preference, a preferred car program, or a preferred amenities preference. Lodging itineraries can include, for example, reservations at a hotel or other lodging, and lodging preferences can be, for example, a preferred hotel program, a high star rating preference, a high user rating preference, a lowest cost preference, a type of bed preference, a special rates preference, a preference for flexible rates, a preferred amenities preference or selectable option, and a closest to destination preference.

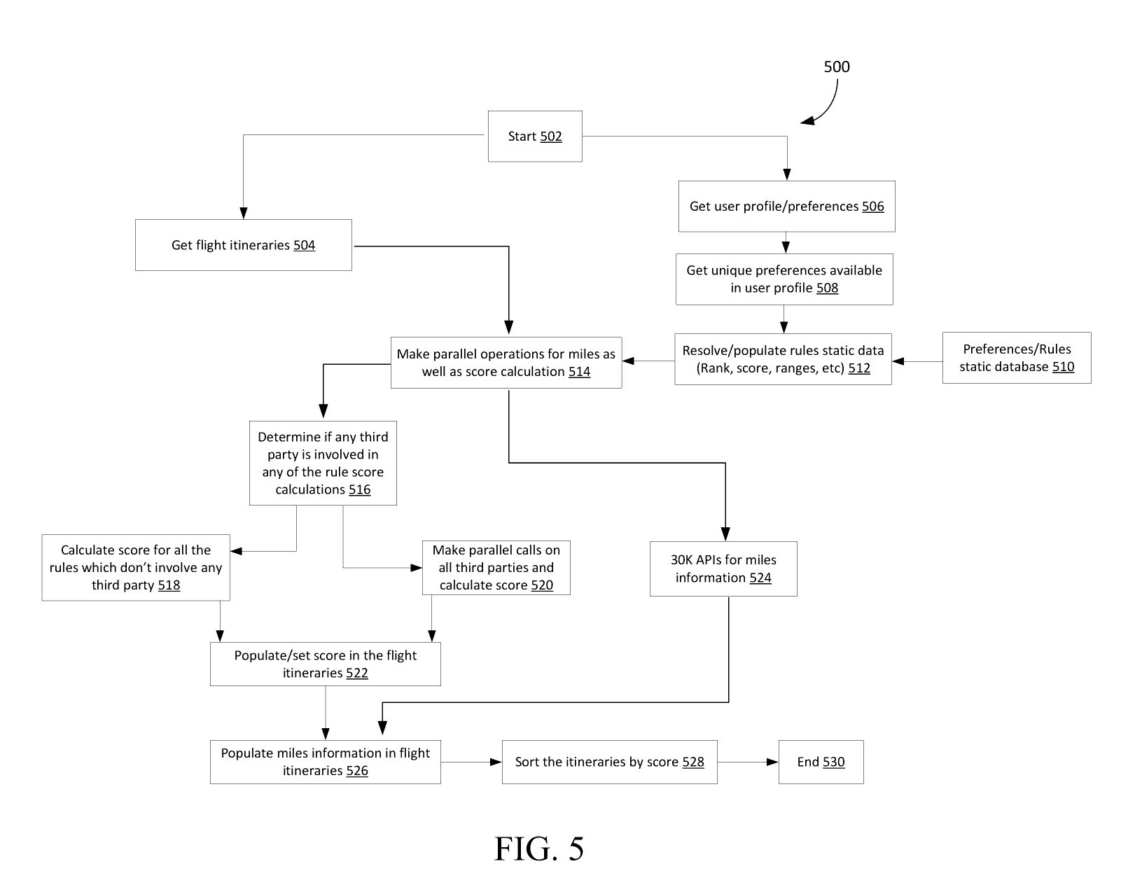

Referring now to FIG. 5, FIG. 5 depicts an example implementation of a method 500 for generating a TRIPSCORE via processes executed in parallel. In some implementations, method 500 can include steps 502-530. In some implementations, all or part of step 504 can be executed in parallel with all or part of steps 506-512. In some implementations, all or part of steps 516-522 can be executed in parallel with step 524.

At step 502, the TRIPSCORE server 200 can begin method 500 by requesting that the itinerary identifier 206 execute step 504 and to retrieve or identify itineraries based on trip information. The itineraries can correspond to parameters specified in a search query received by TRIPSCORE server 200. The itinerary identifier 206 can retrieve corresponding travel itineraries from a data store, which can be local to the TRIPSCORE server 200 or can be accessible to the TRIPSCORE server 200 via, for example, a networks such as any of the networks described above. The itinerary identifier 206 can also request corresponding travel itineraries from one or more other servers. By requesting travel itineraries from other servers in parallel with other processes of method 500 being executed, the TRIPSCORE server 200 can generate a TRIPSCORE more quickly.

In some implementations, at step 502, the TRIPSCORE server 200 can instruct the preference requester 208 and the preference retriever 210 to execute steps 506-512 in parallel with the execution of step 504. At step 506, the preference requester 208 can transmit a request to a client device for preferences. For example, if method 500 is executed responsive to TRIPSCORE server 200 receiving a search request, and the search request does not include an account identifier, the preference requester 208 can transmit a request to the client device and can receive preferences from the client device, and the preference requester 208 can proceed to step 512.

In some implementations, if the search request includes a user account or user identifier, step 506 can be skipped, and the TRIPSCORE server 200 can proceed to step 508. At step 508, the preference retriever 210 can retrieve preferences from a user account. The preference retriever 210 can then proceed to step 512, and can populate a preference ranking and/or preference options from one or more default rankings and one or more default preference options stored in a preference/rules static database 510. The preference retriever can populate a preference ranking and/or preference options in this manner, for example, for any preferences or preference options that are not ranked or have options that are not specified by user account information. The preference retriever 210 can then proceed to step 514.

In some implementations, at step 514, the TRIPSCORE server 200 can initiate steps 516-522 in parallel with step 524. By requesting by initiating execution of these steps in parallel with each other, the TRIPSCORE server 200 can generate a TRIPSCORE in less time than it otherwise could.

In some implementations, at step 516, the preference satisfaction verifier 214 can determine for which preferences information from other servers, third party information, or information not immediately available or accessible to the TRIPSCORE server 200 is required in order to determine whether the preferences are satisfied by an itinerary. For preferences for which information from other servers is not required, the preference satisfaction verifier 214 can proceed to step 518, and the preference satisfaction verifier 214 and the TRIPSCORE generator 216 can calculate preference satisfaction scores for those preferences. For any preferences for which information from other servers is required, the preference satisfaction verifier 214 can proceed to step 520, at which the parallel information retriever 212 can transmit a request to other servers for the required information. Still at step 520, the parallel information retriever 212 can receive the required information from other servers, and the preference satisfaction verifier 214 and the TRIPSCORE generator 216 can calculate preference satisfaction scores for those preferences. The TRIPSCORE generator 216 can proceed to step 522, at which the TRIPSCORE generator 216 can calculate preference contribution scores for the analyzed preferences.

In some implementations, in parallel to steps 516-522, the distance calculator 222 can execute step 524. At step 524, the distance calculator 222 can determine a distance that corresponds to an itinerary, such as a distance travelled. As discussed above in reference to FIG. 2, this can be used, for example, to determine who many frequent flyer miles an itinerary may earn, or can be used to determine how many frequent flyer miles would be required to purchase an itinerary. The distance calculator 222 can then proceed to step 526. This can be a time consuming process, and by performing this process in parallel, a TRIPSCORE can be generated in less time than otherwise.

In some implementations, at step 526, the preference retriever 210 can associate distance information with an itinerary. The preference satisfaction verifier 214 can use the distance information to determine, for example, whether a frequent flyer miles preference is satisfied by an itinerary, and the TRIPSCORE generator 216 can then finish calculating a TRIPSCORE for the itinerary. The TRIPSCORE generator can proceed to step 528, at which the itinerary display engine 224 can display or can cause to be displayed a GUI 100 that displays a list of itineraries ordered by TRIPSCORE. The method 500 can then end at step 530.

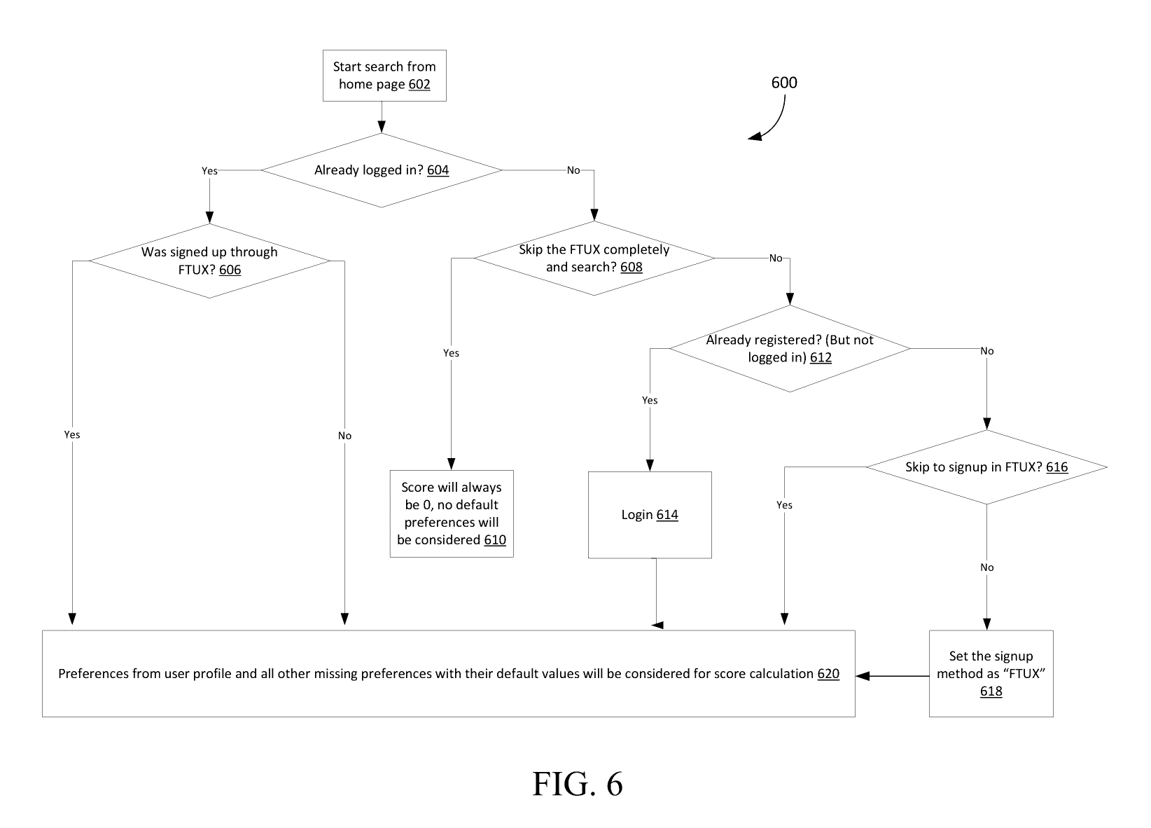

Referring now to FIG. 6, FIG. 6 depicts an example implementation of a method 600 for retrieving preferences. Steps 602-620 can include determining if a search request is associated with a user account, and if so, loading preferences from the user account, and if not, loading default preferences.

In some implementations, at step 602, the TRIPSCORE server 200 can receive a search request from a client device. This can be a search request submitted via a webpage, such as a TRIPSCORE homepage, or can be submitted via a GUI 100. After receiving the search request, the TRIPSCORE server can proceed to step 604.

In some implementations, at step 604, the TRIPSCORE server 200 can determine whether the search request included an account identifier for a user account, and if so, can identify the user account. For example, if a user submitted the search request via a TRIPSCORE webpage, and the user was logged in to a TRIPSCORE account, the search request can be associated with an account identifier by the TRIPSCORE server 200. The TRIPSCORE server 200 can then identify the user account associated with the account identifier, and can proceed to step 606.

In some implementations, at step 606 the TRIPSCORE server 200 can determine whether the user was signed up through a first time user experience (“FTUX”) process, described in more detail below. In an FTUX process, a user may have ranked at least some preferences. The TRIPSCORE server 200 can determine whether the user account went through an FTUX process and thereby ranked some preferences, or whether preferences were ranked in any other fashion, and can proceed to step 620, where the TRIPSCORE server 200 can use any ranking of preferences in the user account in a TRIPSCORE calculation.

Returning to step 604, if the TRIPSCORE server 200 determines that the search request did not include an account identifier, TRIPSCORE server 200 can proceed to step 608 and attempt to initiate an FTUX, which can include submitting user information and/or preference information. At step 608, the TRIPSCORE server 200 can determine whether the user has chosen to skip the FTUX. For example, the user may have been prompted by the TRIPSCORE server 200 via, for example, a TRIPSCORE webpage or a GUI 100, to perform an FTUX responsive to the TRIPSCORE server 200 receiving a search request, and the user may have selected a “skip” option by clicking a skip button on the TRIPSCORE webpage or on the GUI 100. If the user has chosen to skip the FTUX, the TRIPSCORE server 200 can proceed to step 610, and can cause to be displayed search results comprising itineraries. The itineraries can be displayed with no associated TRIPSCORE, or can be associated with an associated TRIPSCORE of zero.

Returning to step 608, if the TRIPSCORE server 200 determines that the user has not chosen to skip the FTUX, the TRIPSCORE server 200 can proceed to step 612. At step 612, the TRIPSCORE server 200 can cause a GUI or a TRIPSCORE webpage to prompt the user to login. The TRIPSCORE server 200 can then determine if a user has logged in. If the TRIPSCORE server 200 determines that a user has logged in, the TRIPSCORE server 200 can proceed to step 614, can initiate login procedures, and can proceed to step 620. If the TRIPSCORE server 200 determines that the user has not logged in or has declined to log in, the TRIPSCORE server 200 can proceed to step 616.

In some implementations, at step 616, the TRIPSCORE server 200 can determine whether a user has chosen to skip creating an account, but would still like to specify preferences to generate a TRIPSCORE. If the user has chosen to skip creating an account, but would still like to specify preferences to generate a TRIPSCORE, the TRIPSCORE server 200 can proceed to step 620, initiate FTUX and not save the information. If the user has not decided to skip creating an account, TRIPSCORE server 200 can proceed to step 618, save any subsequently received preferences to a user account, and TRIPSCORE server 200 can proceed to step 620.

In some implementations, at step 620, the TRIPSCORE server can initiate the FTUX. The FTUX can comprise a number of steps, including (i) the preference requester 208 transmitting a request to the client device to specify and rank four preferences, and (ii) the TRIPSCORE generator 216 generating a TRIPSCORE based on the preferences and preference ranking, wherein the weight assigner 218 assigns a number of weight points to each of the four ranked preferences equal to ten less the rank number of the ranked preference, plus one. The weight assigner 218 further assigns a predetermined number of weight points to a total flight duration preference, and evenly distributes a remaining number of weight points (equal to a total number of weight points less a number of already assigned weight points) to five unranked preferences. The TRIPSCORE generator 216 can thereby generate a TRIPSCORES for a plurality of itineraries identified by the itinerary identifier 206, and the itinerary display engine 224 can cause a GUI or a webpage to display the itineraries to the user in an order based on the TRIPSCORES of the respective itineraries.

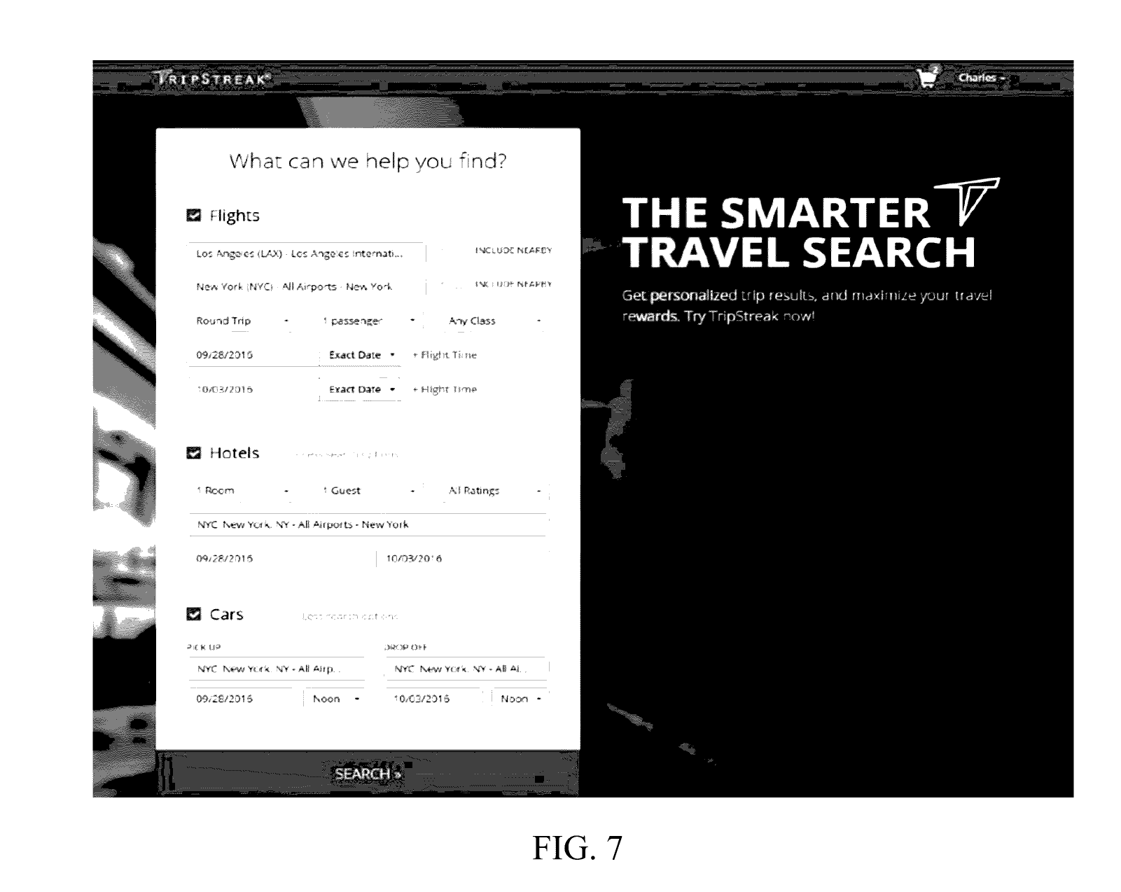

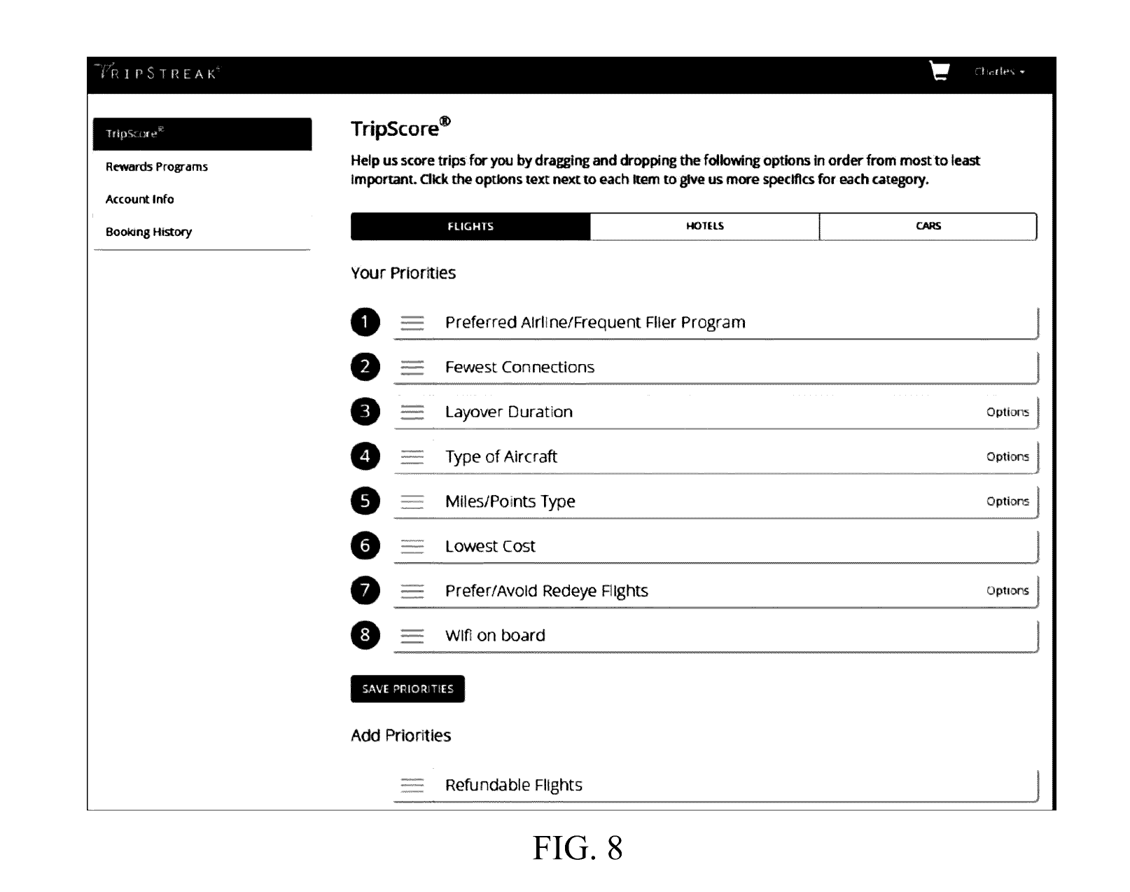

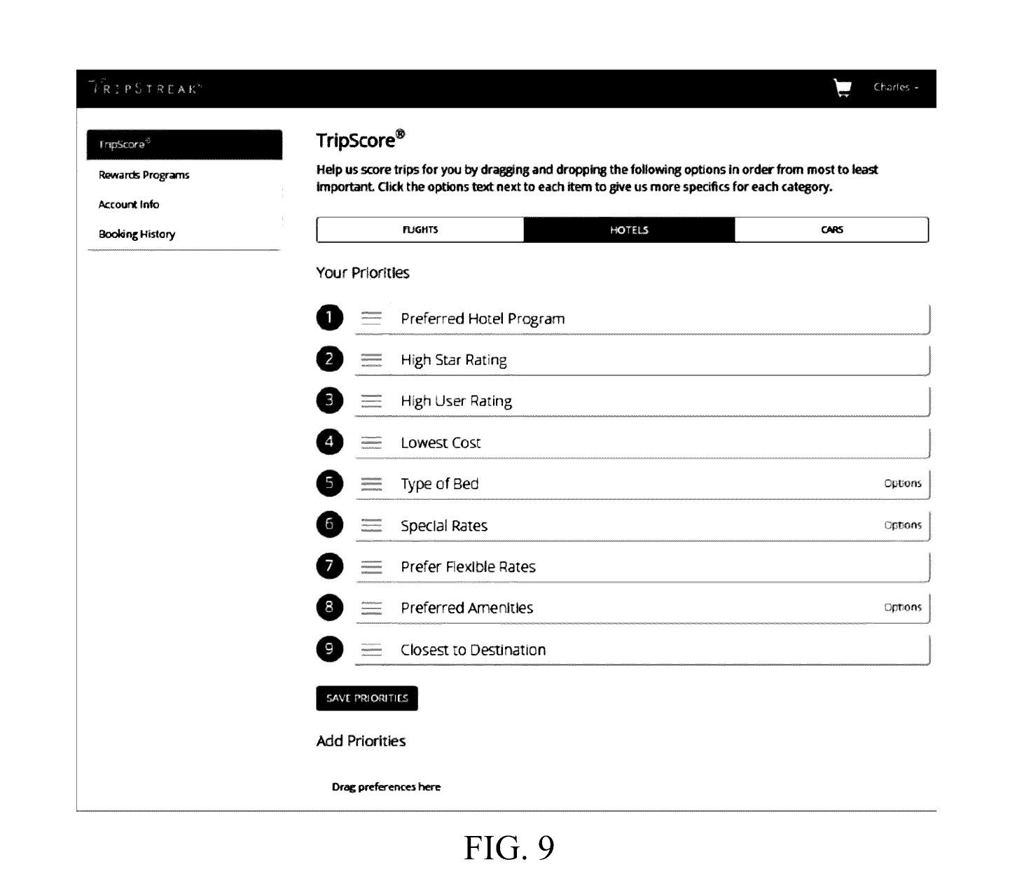

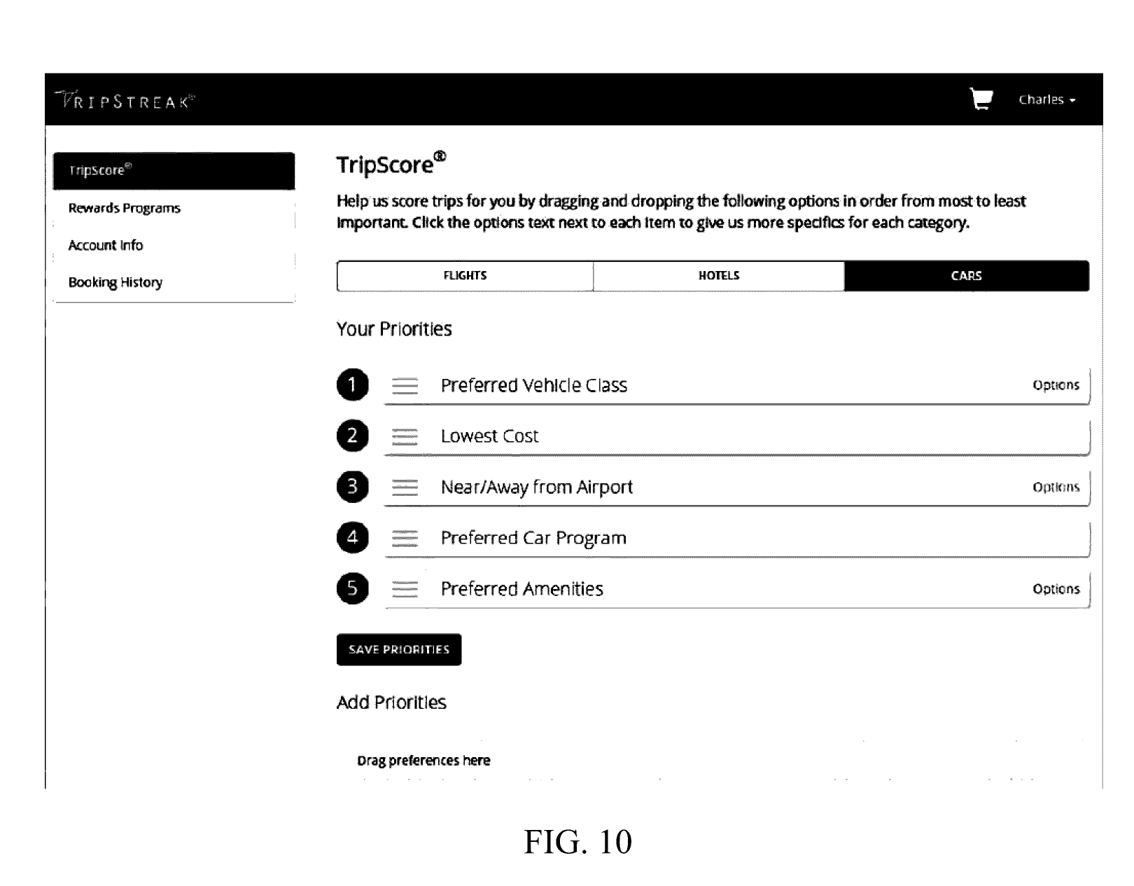

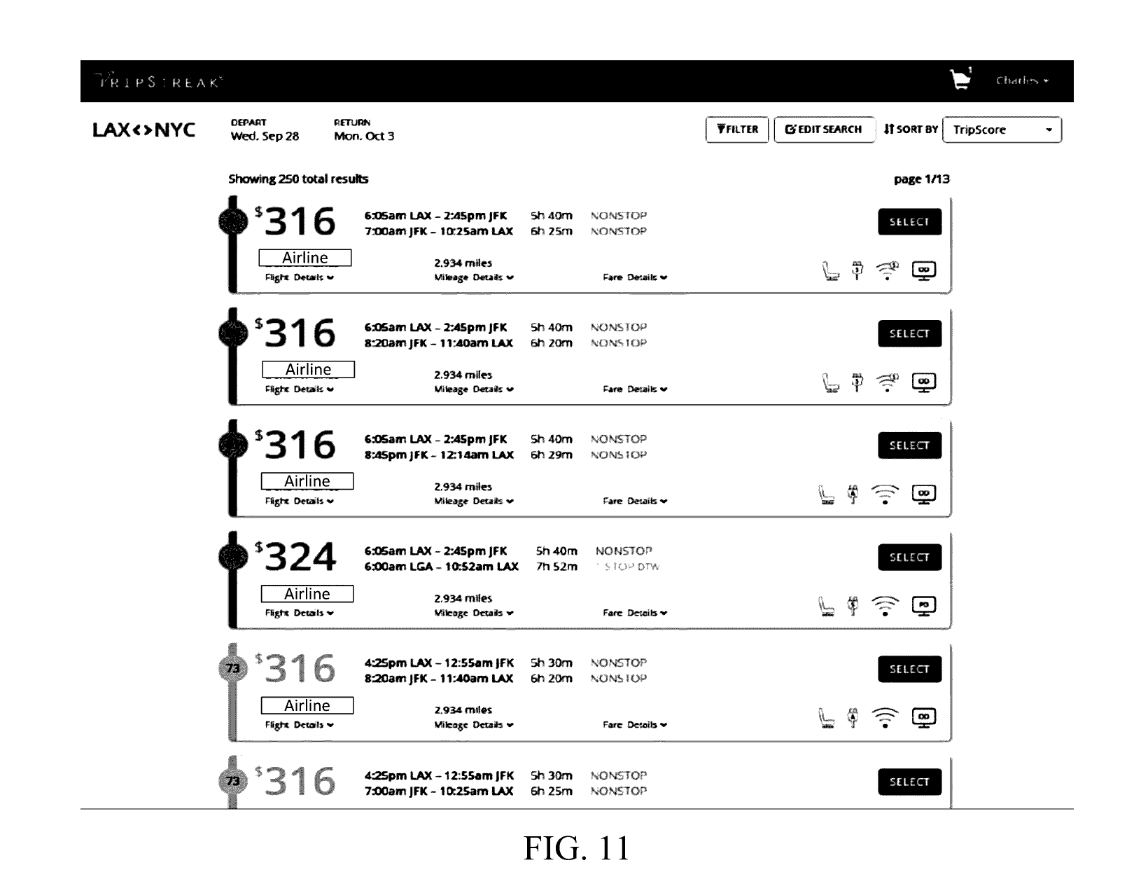

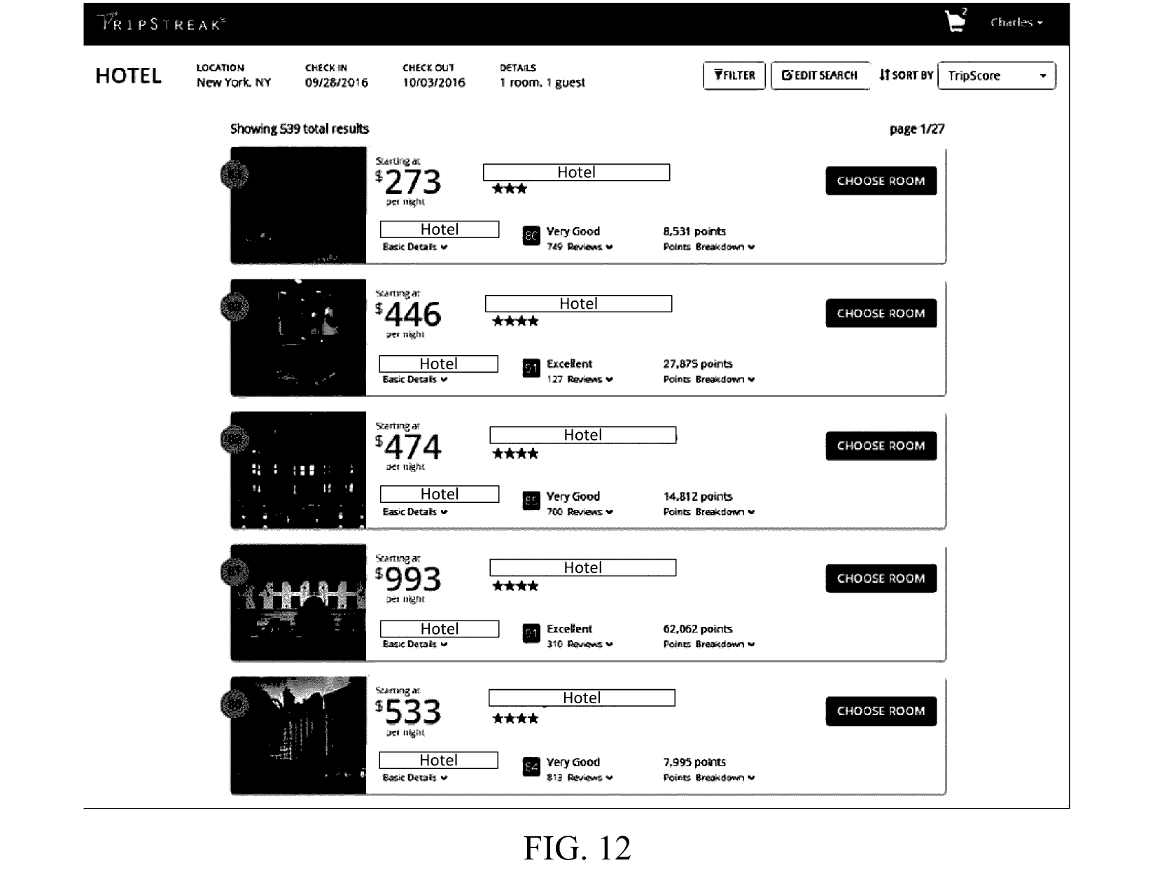

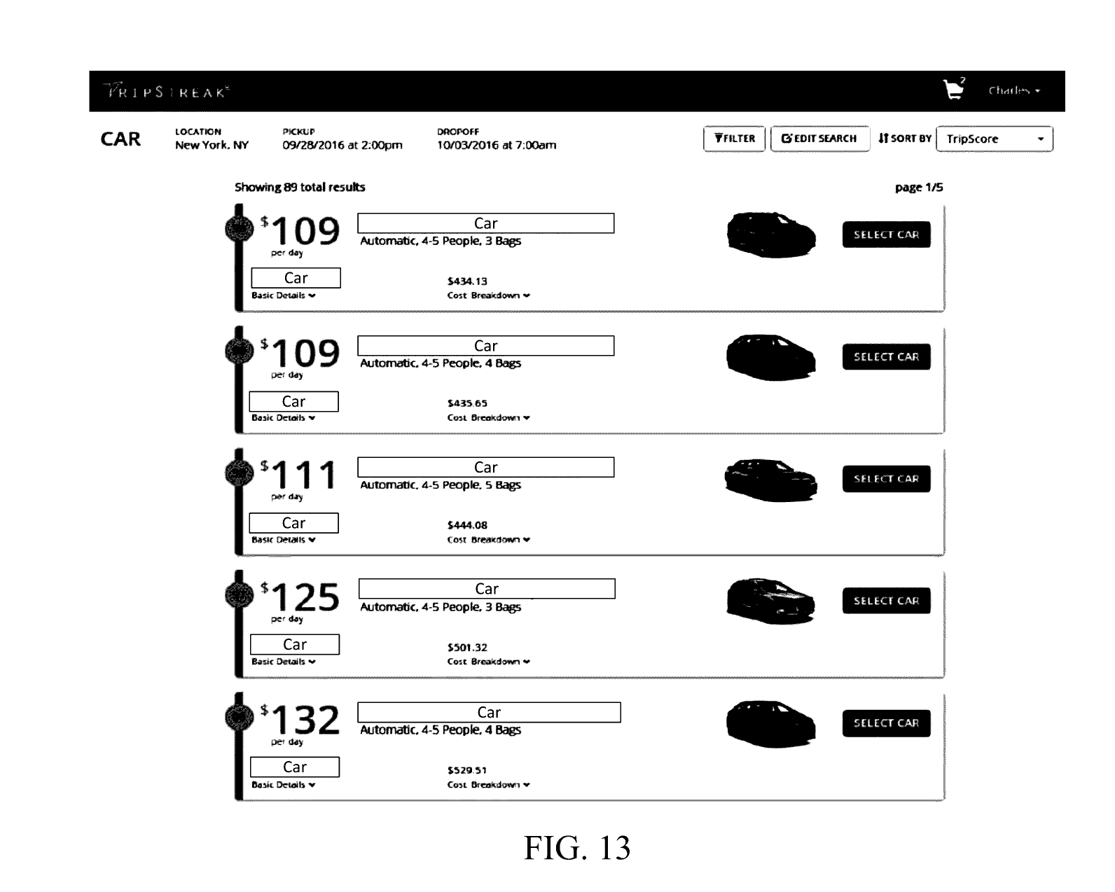

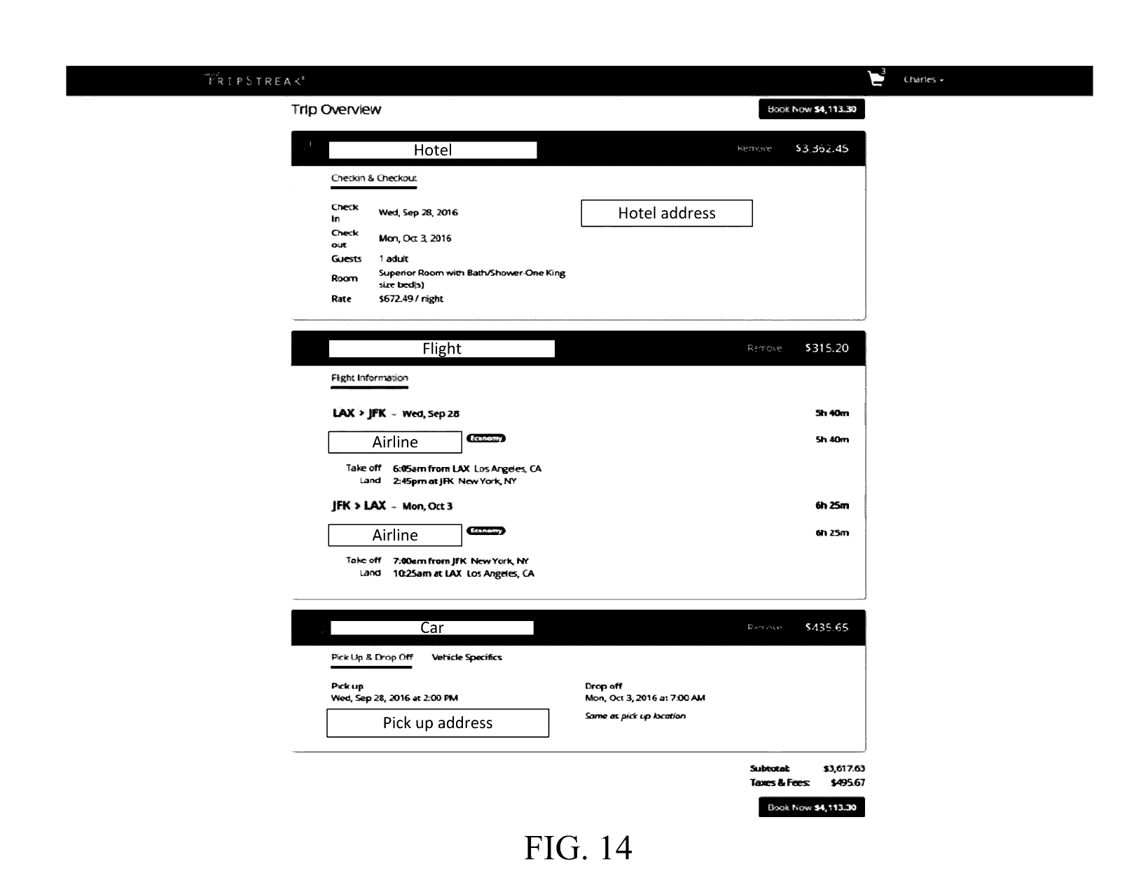

Referring now to FIGS. 7-14 in general, FIGS. 7-14 depict example implementations of graphical user interfaces. FIG. 7 depicts a screenshots of an example implementations of a graphical user interface for submitting a search request. FIG. 8 depicts a screenshots of an example implementations of a graphical user interface for ranking preferences and for selecting preference options related to flights. FIG. 9 depicts an example implementation a graphical user interface for ranking preferences and for selecting preference options related to hotels. FIG. 10 depicts an example implementation a graphical user interface for ranking preferences and for selecting preference options related to cars. FIG. 11 depicts an example implementation a graphical user interface for displaying flight itineraries ranked by TRIPSCORE. FIG. 12 depicts an example implementation a graphical user interface for displaying hotel itineraries ranked by TRIPSCORE. FIG. 13 depicts an example implementation a graphical user interface for displaying car itineraries ranked by TRIPSCORE. FIG. 14 depicts an example implementation a graphical user interface for displaying a shopping cart that includes a hotel itinerary, a flight itinerary, and a car itinerary. These graphical user interfaces can be a GUI 100, a GUI 120, or any other appropriate GUI.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A method for generating a TRIPSCORE, comprising:
receiving, by one or more servers from a client device, a search request, the search request comprising trip information;
identifying, by the one or more servers, a plurality of itineraries based on the trip information;
retrieving, by the one or more servers from a data store, preference information including a plurality of preferences and a ranking of a ranked subset of the plurality of preferences;
determining, by the one or more servers for each itinerary, a correspondence between the respective itinerary and each respective preference of the plurality of preferences;
calculating, by the one or more servers for each itinerary, a TRIPSCORE for each itinerary based on the correspondences, wherein each correspondence between the itinerary and a preference of the ranked subset of preferences is weighted based on the ranking of preferences;
displaying, by the one or more servers, a predetermined number of itineraries having a highest TRIPSCORE.

2. The method of claim 1, wherein the calculating a TRIPSCORE for each itinerary comprises:
assigning weight points to each of the preferences of the ranked subset of preferences based on the ranking;
calculating, by the one or more servers, a remaining number of weight points to be distributed based (i) a predetermined number of weight points to be distributed and (ii) a total number of assigned weight points;
evenly assigning the remaining number of weight points to preferences of the plurality of preferences that are not included in the ranked subset of preferences; and
determining a TRIPSCORE for each itinerary based on the correspondences between the itineraries and the preferences, and further based on the of number weight points assigned to each of the preferences.

3. The method of claim 2, wherein determining a TRIPSCORE for each itinerary based on the correspondences between the itineraries and the preferences, and further based on the of number weight points assigned to each of the preferences comprises:
initializing a TRIPSCORE for the itinerary to zero;
assigning, by the one or more servers for each preference, a preference satisfaction score to the preference based on the correspondence between the itinerary and the preference;
multiplying, by the one or more servers, the preference satisfaction score by the number of weight points assigned to the corresponding preference to generate a total preference contribution; and
adding, by the one or more servers, the total preference contribution to the TRIPSCORE.

4. The method of claim 3, wherein each itinerary of the plurality of itineraries is associated with a characteristic quantity, wherein a preference of the plurality of preferences is a preference for the characteristic quantity to be minimized, further comprising:
setting, for a best itinerary associated with a smallest characteristic quantity out of the itineraries of the plurality of itineraries, a highest preference satisfaction score for the preference; and
respectively setting, for each other itinerary of the plurality of itineraries, a preference satisfaction score for the preference based on a deviation of the characteristic quantity associated with the itinerary from the characteristic quantity associated with the best itinerary.

5. The method of claim 4, wherein the characteristic quantity relates to at least one of:
flight layover, airfare, and total travel time.

6. The method of claim 3, further comprising:
determining, by the one or more servers, that one of the preferences relates to parallel information;
requesting, by the one or more servers, the parallel information from one or more secondary servers; and
performing, by the one or more servers, at least part of the method for generating a TRIPSCORE in parallel with the retrieving the parallel information, the at least part of the method for generating a TRIPSCORE related to processes that do not require parallel information.

7. The method of claim 6, wherein the requesting the parallel information from the one or more secondary servers comprises making requests in parallel to a plurality of secondary servers.

8. The method of claim 7, wherein the parallel information includes loyalty program information.

9. The method of claim 3, wherein assigning weight points to each of the preferences of the ranked subset of preferences based on the ranking comprises:
determining, by the one or more servers, that the plurality of preferences is a set of a first number of preferences;
iteratively assigning, for each ranked preference of the subset of ranked preferences, a number of weight points equal to the first number less the rank number of the ranked preference, plus one.

10. The method of claim 9, wherein the predetermined number of weight points to be distributed is equal to:
$${\sum }_{n = 1}^{k} n$$
where k is equal to the first number.

11. The method of claim 1, wherein at least one of the preferences corresponds to at least one of: airline preference, loyalty program, cost, travel connections, layover, redeye, aircraft type, frequent flyer miles, refunds, travel plan chances, cancellation policies, room type, bed type, hotel star ratings, user ratings, and rental car type.

12. The method of claim 1, wherein the search request includes an account identifier, and wherein retrieving, by the one or more servers from a data store, preference information comprises retrieving account information associated with the account identifier, the account information including the preference information.

13. The method of claim 1, further comprising:
transmitting, by the one or more servers to the client device, a request for the preference information responsive to receiving the search request;
receiving and storing in a data store, by the one or more servers from the client device, the preference information.

14. A method for configuring a travel account, comprising:
receiving, by one or more servers from a client device, a search request, the search request comprising trip information;
transmitting, by the one or more servers to the client device, graphical user interface information that, when executed, causes to be displayed a graphical user interface, wherein the graphical user interface:
displays an interactive object comprising a predetermined number of preferences in a predetermined ranked order;
allows the preferences to be reordered via interaction with the interactive object; and
provides an option to save the order of the preferences;
identifying, by the one or more servers, a plurality of itineraries based on the trip information;
retrieving, by the one or more servers from a data store, preference information including a plurality of preferences and a ranking of a ranked subset of the plurality of preferences;
determining, by the one or more servers for each itinerary, a correspondence between the respective itinerary and each respective preference of the plurality of preferences;
calculating, by the one or more servers for each itinerary, a TRIPSCORE for each itinerary based on the correspondences, wherein each correspondence between the itinerary and a preference of the ranked subset of preferences is weighted based on the ranking of preferences;
displaying, by the one or more servers, a predetermined number of itineraries having a highest TRIPSCORE.

15. The method of claim 14, wherein:
the calculating a TRIPSCORE for each itinerary comprises:
assigning weight points to each of the preferences of the ranked subset of preferences based on the ranking;
calculating, by the one or more servers, a remaining number of weight points to be distributed based (i) a predetermined number of weight points to be distributed and (ii) a total number of assigned weight points;
evenly assigning the remaining number of weight points to preferences of the plurality of preferences that are not included in the ranked subset of preferences; and
determining a TRIPSCORE for each itinerary based on the correspondences between the itineraries and the preferences, and further based on the of number weight points assigned to each of the preferences, and
the determining a TRIPSCORE for each itinerary based on the correspondences between the itineraries and the preferences, and further based on the of number weight points assigned to each of the preferences comprises:
initializing a TRIPSCORE for the itinerary to zero;
assigning, by the one or more servers for each preference, a preference satisfaction score to the preference based on the correspondence between the itinerary and the preference;
multiplying, by the one or more servers, the preference satisfaction score by the number of weight points assigned to the corresponding preference to generate a total preference contribution; and
adding, by the one or more servers, the total preference contribution to the TRIPSCORE.

16. The method of claim 15, wherein the search request comprises an account identifier, and both the predetermined number of preferences and the predetermined ranked order are based on an account corresponding to the account identifier.

17. A system for generating a TRIPSCORE, comprising:
a processor;
a memory coupled to the processor, the memory storing computer-executable instructions, which when executed by the processor, cause the processor to:
receive, by one or more servers from a client device, a search request, the search request comprising trip information;
identify, by the one or more servers, a plurality of itineraries based on the trip information;
retrieve, by the one or more servers from a data store, preference information including a plurality of preferences and a ranking of a ranked subset of the plurality of preferences;
determine, by the one or more servers for each itinerary, a correspondence between the respective itinerary and each respective preference of the plurality of preferences;
calculate, by the one or more servers for each itinerary, a TRIPSCORE for each itinerary based on the correspondences, wherein each correspondence between the itinerary and a preference of the ranked subset of preferences is weighted based on the ranking of preferences;
display, by the one or more servers, a predetermined number of itineraries having a highest TRIPSCORE.

18. The system of claim 17, wherein calculate a TRIPSCORE for each itinerary comprises:
assign weight points to each of the preferences of the ranked subset of preferences based on the ranking;
calculate, by the one or more servers, a remaining number of weight points to be distributed based (i) a predetermined number of weight points to be distributed and (ii) a total number of assigned weight points;
evenly assign the remaining number of weight points to preferences of the plurality of preferences that are not included in the ranked subset of preferences; and
determine a TRIPSCORE for each itinerary based on the correspondences between the itineraries and the preferences, and further based on the of number weight points assigned to each of the preferences.

19. The system of claim 18, wherein determine a TRIPSCORE for each itinerary based on the correspondences between the itineraries and the preferences, and further based on the of number weight points assigned to each of the preferences comprises:
initialize a TRIPSCORE for the itinerary to zero;
assigning, by the one or more servers for each preference, a preference satisfaction score to the preference based on the correspondence between the itinerary and the preference;
multiply, by the one or more servers, the preference satisfaction score by the number of weight points assigned to the corresponding preference to generate a total preference contribution; and
add, by the one or more servers, the total preference contribution to the TRIPSCORE.

20. The system of claim 19, wherein the computer-executable instructions, when executed by the processor, further cause the processor to:
transmit, by the one or more servers to the client device, graphical user interface information that, when executed, causes to be displayed a graphical user interface, wherein the graphical user interface:
displays an interactive object comprising a predetermined number of preferences in a predetermined ranked order;
allows the preferences to be reordered via interaction with the interactive object; and
provides an option to save the order of the preferences.
